(19) United States
(12) Patent Application Publication
(10) Pub. No.: US 2013/0095422 A1
(43) Pub. Date: Apr. 18, 2013

(54) TONER

(71) Applicants: Atsushi YAMAMOTO, Shizuoka (JP); Shinya Nakayama, Shizuoka (JP); Masahide Yamada, Shizuoka (JP); Hideyuki Santo, Shizuoka (JP); Daiki Yamashita, Kanagawa (JP); Ryota Inoue, Shizuoka (JP)

(72) Inventors: Atsushi YAMAMOTO, Shizuoka (JP); Shinya Nakayama, Shizuoka (JP); Masahide Yamada, Shizuoka (JP); Hideyuki Santo, Shizuoka (JP); Daiki Yamashita, Kanagawa (JP); Ryota Inoue, Shizuoka (JP)

(21) Appl. No.: 13/632,357

(22) Filed: Oct. 1, 2012

(30) Foreign Application Priority Data
Oct. 17, 2011 (JP) 2011-227828

(51) Int. Cl. C08G 63/16; C08G 63/91; G03G 9/087; G03G 9/16

(52) U.S. Cl. 430/109.4; 528/302; 528/272; 525/440.12; 525/440.01; 430/137.19

(57) ABSTRACT

A toner, including a crystalline resin as a binder resin, wherein the toner comprises a THF-soluble component in a weight-average molecular weight not less than 20,000, and has a 50% wettability not less than 20% by volume when subjected to a methanol wettability test.

### CROSS-REFERENCE TO RELATED APPLICATIONS

This patent application is based on and claims priority pursuant to 35 U.S.C. §119 to Japanese Patent Application No. 2011-227828 filed on Oct. 17, 2011 in the Japanese Patent Office, the entire disclosure of which is hereby incorporated herein by reference.

### FIELD OF THE INVENTION

The present invention relates to a toner for use image formation using electrostatic copying process, e.g., in copiers, facsimiles, printers, etc.

### BACKGROUND OF THE INVENTION

Printers and MFPs using electrophotographic image forming apparatuses have been required to consider the environment recently. For example, printers and MFPs lower their power consumptions to decrease emission of CO₂, and biomass materials are used to close to carbon neutral. Because of this background, a toner for electrophotography is required to decrease its fixable temperature, and a binder resin for use in the toner is suggested to include a crystalline resin instantly dissolving with heat fixing the toner. Further, the crystalline resin is even used as a main component of the binder resin.

However, the toner using the crystalline resin as a main component largely varies in chargeability due to the environment and has insufficient fixability although instantly dissolving with heat.

Japanese published unexamined application No. 2010-077419 discloses a crystalline particulate material having a specific storage elasticity and a specific loss elastic modulus for the purpose of providing a particulate resin having good low-temperature fixability and anti-blocking, and further discloses the crystalline resin is a block resin formed of crystalline polyester and an amorphous polyurethane.

The block resin includes a crystalline resin having a urethane bond in its main chain, and links the crystalline polyester with the urethane bond to polymerize the crystalline resin. Consequently, the toner can prevent its viscoelasticity from deteriorating with heat and have a wider fixable temperature range. However, the toner using the crystalline resin as a main component still largely varies in chargeability due to the environment and has insufficient fixability.

Because of these reasons, a need exist for a toner including a crystalline resin, and having sufficient chargeability, less variation in chargeability due to the environment and sufficient fixability.

### SUMMARY OF THE INVENTION

Accordingly, one object of the present invention to provide a toner including a crystalline resin, and having sufficient chargeability, less variation in chargeability due to the environment and sufficient fixability.

This object and other objects of the present invention, either individually or collectively, have been satisfied by the discovery of a toner, comprising a crystalline resin as a binder resin,

wherein the toner comprises a THF-soluble component in a weight-average molecular weight not less than 20,000, and has a 50% wettability not less than 20% by volume when subjected to a methanol wettability test.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram after fitting in calculating crystallinity of the toner of the present invention;

FIG. 2 is a schematic view illustrating a two-component developing means in an image forming apparatus using the toner of the present invention; and

FIG. 3 is a schematic view illustrating a process cartridge using the toner of the present invention;

FIG. 4 is a scanning electron micrographic image of the toner prepared in Example 1;

FIG. 5 is a scanning electron micrographic image of the toner prepared in Comparative Example 1;

FIG. 6 is a scanning electron micrographic image of the toner prepared in Comparative Example 4;

FIG. 7 is a cross-sectional view illustrating a liquid-column resonant droplet former;

FIG. 8 is a cross-sectional view illustrating a liquid-column resonant droplet unit;

FIGS. 9A to 9D are a cross-sectional views illustrating discharge openings;

FIG. 10 is a cross-sectional view illustrating another liquid-column resonant droplet former; and

FIG. 11 a schematic view illustrating a toner preparation apparatus.

### DETAILED DESCRIPTION OF THE INVENTION

The present invention provides a toner including a crystalline resin, and having sufficient chargeability, less variation in chargeability due to the environment and sufficient fixability.

More particularly, the present invention relates to a toner, comprising a crystalline resin as a binder resin,

wherein the toner comprises a THF-soluble component in a weight-average molecular weight not less than 20,000, and has a 50% wettability not less than 20% by volume when subjected to a methanol wettability test.

A toner fixable at low temperature melts even at low temperature and has low viscosity to adhere to a printed medium such as a paper. Meanwhile, the toner needs heat-resistant storage stability and may not soften even at an upper limit temperature in a guaranteed storage temperature. Namely, an ideal thermo property of a toner in consideration of both low-temperature fixability and heat-resistant storage stability is sharp meltability with which the toner does not melt until the temperature comes to the upper limit in a guaranteed storage temperature and instantly melts and has low viscosity to adhere to a paper at the upper limit temperature. A resin having sharp meltability is used as a binder resin to prepare such a toner. The crystalline resin is known as a resin having sharp meltability. The crystalline resin is a solid when crystallized, and melts with heat and instantly has low viscosity. Therefore, the crystalline resin can be an ideal binder resin for toner when having a melting point in a preferable range.

However, when a toner noticeably deteriorates in viscoelasticity after melted, i.e. when the toner has an inner cohesive force too low, the melted toner separates between a heat member such as a fixing roller and a fixing belt and a paper when fixed, i.e., the hot offset phenomenon occurs, resulting in noticeable deterioration of image quality. Therefore, the toner needs to have a specific inner cohesive force. As a means of assuring the inner cohesive force, a method of lengthening a molecular chain of the binder resin is available. Specifically, when a toner includes a THF-soluble component in a weight-average molecular weight not less than 20,000, the hot offset phenomenon is prevented.

Compared with a single crystal of a low-molecular-weight compound, the crystalline resin has longer and larger molecules. Therefore, the crystalline resin typically does not have a completely ordered crystal structure and a lamella layer including multilayered surfaces each formed of a periodical folding structure is disorderly present therein. The periodical folding structure is hard because of having intermolecular force, but disorderly sites, partial amorphous sites around the disorderly sites or the lamella layers easily move or transform. Even when the crystalline resin is pulverized to form a few um order particles as amorphous resins widely used as resins for conventional toners, a pulverizing force is consumed to deform the resin and it is very difficult to prepare a toner with the crystalline resin by pulverization methods.

Therefore, a toner including the crystalline resin is granulated or prepared in an aqueous medium by dissolution suspension methods, fusion suspension methods, condensation methods, etc.

It is thought that the toner using the crystalline resin as a main component largely varies in chargeability due to the environment because of being prepared in an aqueous medium and likely to have a material having a functional group having high polarity such as a carboxyl group on its surface.

Therefore, a toner having a 50% wettability not less than 20% by volume when subjected to a methanol wettability test is thought to have sufficient chargeability and less variation thereof due to the environment.

A polymeric crystalline resin having a urethane bond is prepared by e.g., linking or elongating a polymer having a crystalline polyester structure with isocyanate. A toner including a crystalline resin as a main component of the binder resin has a wide fixable temperature width and high flexibility in designing fixing process as a toner for electrophotography.

In a method of preparing a toner including a crystalline resin as a main component in an aqueous medium, including a process of granulating a toner including a crystalline resin as a main component of the binder resin in an aqueous medium, a process of washing the toner, and a process of drying the washed toner to remove moisture, when the process of washing the toner includes a process of heating at alkaline pH, the toner has sufficient chargeability, less variation thereof due to the environment and lower minimum fixable temperature.

This is because it is thought that a material having a functional group having high polarity such as a carboxyl group present on the surface of a toner melts and disperses in an aqueous medium to be removed from the toner, resulting in improvement of hydrophobicity on the surface of the toner. The reason why the minimum fixable temperature lowers is not clarified, but when the material having a functional group having high polarity is particularly a polymer, a fixing inhibitor is thought to be removed if removed. Besides, the binder resin is thought to be slightly hydrolyzed to have a moderate polarity insofar as the chargeability is not influenced and improved fixability.

In addition, a toner prepared by a method using a crystalline resin prepolymer having an isocyanate group has high maximum fixable temperature and wider fixable temperature. This is because it is thought that the prepolymer is polymerized or has a network structure with another prepolymer when heated with alkaline.

Heating with alkaline in the present invention is effective as well when the surface of a toner is covered with the crystalline resin besides a case where the crystalline resin is a main component. However, a toner preferably includes the crystalline resin as a main component in terms of low-temperature fixability. When the surface of a toner is covered with an amorphous resin, a material having a functional group having high polarity can be removed, but the amorphous resin has an ester cut due to hydrolysis when heated with alkaline, and noticeably varies in properties and is plasticized to be porous. The toner has such a large surface area, resulting in increase of chargeability variation due to the environment and deterioration of heat-resistant storage stability.

In the method of preparing a toner including a crystalline resin as a main component in an aqueous medium, including a process of granulating a toner including a crystalline resin as a main component of the binder resin in an aqueous medium, a process of washing the toner, and a process of drying the washed toner to remove moisture, excluding the material having a functional group having high polarity such as a carboxyl group from the aqueous medium or the binder resin can prepare the toner of the present invention as well. Polar materials in the aqueous medium include a surfactant, a high-polarity polymeric dispersant, a particulate resin, a thickener, etc. The method including heating with alkaline is preferably used in terms of toner yield and cost.

In a method of not granulating a toner in an aqueous medium, e.g., discharging a toner composition liquid including at least a binder resin and a colorant from a through-hole to form a droplet, the resultant toner having a 50% wettability (W(50%)) not less than 20% by volume is thought to have sufficient chargeability and less variation thereof.

It is thought this is because a material having a high-polarity functional group such as a carboxyl group is difficult to be present on the surface of the resultant toner and hydrophobicity thereof improves in this method.

The composition liquid may be a liquid in which toner components are dissolved or dispersed in a solvent or may not include a solvent, and a part of all of the toner components are dissolved and mixed in the liquid.

As toner materials, the same materials for conventional toners for electrophotography if the toner composition liquid can be prepared. The toner composition liquid is formed to a microscopic droplet by the droplet discharger, and the microscopic droplet is solidified and collected by a droplet solidifying and collecting means to prepare a desired toner.

Binder resins are not particularly limited if a crystalline resin is included in an amount not less than 50% by weight based on total weight of the binder resin. The binder resin can properly be selected according to the purposes, the crystalline resin and the amorphous resin may be combined, and it is preferable that the binder resin substantially includes the crystalline resin as a main component.

The binder resin preferably includes the crystalline resin in an amount not less than 65% by weight, more preferably not less than 80% by weight, and most preferably not less than 95% by weight such that the crystalline resin exerts its effects of low-temperature fixability and heat-resistant storage stability most. When less than 50% by weight, the binder resin does not have sufficient sharp meltability, resulting in difficulty for the resultant toner to have low-temperature fixability and heat-resistant storage stability.

Crystallinity in the present invention is a property of quickly melting with heat having a ratio (melting point/maximum peak temperature of melting heat) of a melting point measured by an elevated flow tester to a maximum peak temperature of melting heat measured by differential scanning calorimeter (DSC) of from 0.80 to 1.55. A resin having this property is the crystalline resin.

Amorphousness is a property of moderately melting with heat having ratio (melting point/maximum peak temperature of melting heat) of a melting point to a maximum peak temperature of melting heat greater than 1.55. A resin having this property is the amorphous resin.

The melting point of a resin or a toner can measured by flow tester CFT-500D from Shimadzu Corp. A load of 1.96 Mpa was applied to 1 g of a sample with a plunger thereof while heated at 6° C./min, and pushed out from a nozzle having a diameter of 1 mm and a length of lmm. A temperature at which a half of the sample was flowed out was determined as a softening point.

The maximum peak temperature of melting heat of a resin or a toner can be measured by DSC TA-60WS and DSC-60 from Shimadzu Corp. After melted at 130° C., a sample is cooled at 1.0° C./min from 130 to 70° C., and further cooled at 0.5° C./min from 70 to 10° C. An endothermic and exothermic variation is measured by DSC while heating at 20° C./min to draw a diagram of an endothermic and exothermic amount and a temperature. An endothermic peak temperature is Ta* at from 20 to 100° C. When there are plural endothermic peaks, the peak temperature having the largest endothermic amount is Ta*. Then, after the sample is stored at (Ta*−10)° C. for 6 hrs, the sample is further stored at (Ta*−15)° C. for 6 hrs. Next, after the sample is cooled by DSC at 10° C./min to have a temperature of 0° C., the sample is heated at 20° C./min to measure the endothermic and exothermic variation. The same diagram is drawn, and a temperature correspondent to a maximum peak of the endothermic and exothermic amount is a maximum peak temperature of the melting heat.

The toner preferably includes a THF-soluble component in a weight-average molecular weight of from 20,000 to 100,000, more preferably from 25,000 to 70,000, and more preferably from 30,000 to 50,000. When less than 20,000, hot offset phenomena tend to occur. When greater than 100,000, the toner has such a high viscoelasticity that the toner is difficult to deform and adhere to a paper.

Specific examples of the crystalline resin include, but are not limited to any crystalline resins such as a polyester resin, a polyurethane resin, a polyurea resin, a polyamide resin, a polyether resin, a vinyl resin and a modified crystalline resin. These can be used alone or in combination. Among these resins, the polyester resin, polyurethane resin, polyurea resin, polyamide resin, and polyether resin are preferably used. Resins including a urethane skeleton and/or a urea skeleton are more preferably used. A straight-chain polyester resin and a complex resin including the straight-chain polyester resin are furthermore preferably used.

The polyester resin, the polyurea resin, a urethane-modified polyester resin, a urea-modified polyester resin, etc. are preferably used as the resins including a urethane skeleton and/or a urea skeleton.

The urethane-modified polyester resin is formed from a reaction between a polyester resin having an isocyanate group at the end and polyol. The urea-modified polyester resin is formed from a reaction between a polyester resin and amines.

The crystalline resin preferably has a maximum peak temperature of the melting heat of from 45 to 70° C., more preferably from 53 to 65° C., and most preferably from 58 to 62° C. When lower than 45° C., the low-temperature fixability improves, but the heat-resistant storage stability deteriorates. When higher than 70° C., the heat-resistant storage stability improves, but the low-temperature fixability deteriorates.

The crystalline resin has a ratio (melting point/maximum peak temperature of melting heat) of a melting point to a maximum peak temperature of melting heat of from 0.80 to 1.55, preferably from 0.85 to 1.25, more preferably from 0.90 to 1.20, and most preferably from 0.90 to 1.19. The less the ratio, the quicker the resin melts and the better the low-temperature fixability and heat-resistant storage stability.

A dynamic viscoelasticity (a storage modulus G′ and a loss elastic modulus G″) of the resin and the toner can be measured by a dynamic viscoelasticity measurer such as ARES from TA Instrument, USA. A sample is formed to a pellet having a diameter of 8 mm and a thickness of fro 1 to 2 mm, fixed on a parallel plate having a diameter of 8 mm, stabilized at 40° C., heated to have a temperature of 200° C. at a frequency of 1 Hz (6.28 rad/s), a distortion amount of 0.1% and a rate of temperature increase of 2.0° C./min to measure the dynamic viscoelasticity.

The crystalline resin preferably has a weight-average molecular weight (Mw) of from 2,000 to 100,000, more preferably from 5,000 to 60,000, and most preferably from 8,000 to 30,000 in terms of fixability. When less than 2,000, the hot offset resistance tends to deteriorate, and when greater than 100,000, the low-temperature fixability tends to deteriorate.

In the present invention, the weight-average molecular weight (Mw) of the resin can be measured by gel permeation chromatography (GPC) measurement method such as GPC-8220GPC from Tosoh Corp. TSKgeI SuperHZM-H 15 cm Triple from Tosoh Corp. is used as column. A resin is dissolved in THF including a stabilizer from Wako Pure Chemical Industries, Ltd. to have a concentration of 0.15%, and the solution is filtered with a 0.2 μm filter to use 100 μl of the filtered liquid as a sample. The sample is measure in an environment of 40° C. at a flow rate of 0.35 ml/min. When measuring a molecular weight of the sample, a molecular weight distribution of the sample is determined from a relation between a logarithmic value of a calibration curve prepared from several monodispersion polystyrene standard samples and a counter number. As the polystyrene standard samples for preparing the calibration curve, Showdex STANDARD Std. No. S-7300, S-210, S-390, S-875, S-1980, S-10.9, S-629, S-3.0 and S-0.580 and toluene are used. An RI (refraction index) detector is used as a detector.

Specific examples of the polyester resin include a polycondensed polyester resin, a lactone ring-opening polymer, a polyhydroxy carboxylic acid, etc. synthesized from polyol and a polycarboxylic acid. Among these, a polycondensed polyester resin formed of diol and a dicarboxylic acid is preferably used in terms of crystallinity.

The crystalline polyester resin in the present invention includes an elongated material with urethane and a resin having a polyester block.

The resin having a polyester block has an endothermic amount not less than 25 mJ/mg when measured by a DSC. The resin having a polyester block has an endothermic amount less than 25 mJ/mg is not included in the crystalline polyester resin.

The polyol includes diol and polyols having 3 to 8 or more valences.

Specific examples of the diol include, but are not limited to aliphatic diols such as straight-chain aliphatic diols and branched-chain aliphatic diols; alkylene ether glycols having 4 to 36 carbon atoms; alicyclic diols having 4 to 36 carbon atoms; alkylene oxides (AO) of the alicyclic diols; alkylene oxide adducts of bisphenols; polylactone diols; polybutadiene diols; diols having a carboxyl group; diols having a sulfonic acid group or a sulfamic acid group; diols having other functional groups such as their salts. Among these diols, the branched-chain aliphatic diols having 2 to 36 carbon atoms are preferably used, and the straight-chain aliphatic diols are more preferably used. These can be used alone or in combination.

The diol preferably includes the straight-chain aliphatic diol in an amount not less than 80% by mol, and preferably not less than 90% by mol. When 80% or more, the resin improves in crystallinity, low-temperature fixability and heat-resistant storage stability, and hardness.

Specific examples of the straight-chain aliphatic diols include, but are not limited to ethylene glycol, 1,3-propanediol, 1,4-butanediol, 1,5-pentadiol, 1,6-hexanediol, 1,7-heptanediol, 1,8-octanediol, 1,9-nonanediol, 1,10-decanediol, 1,11-undecanediol, 1,12-dodecanedol, 1,13-tridecanediol, 1,14-tetradecanediol, 1,18-octadecanediol, 1,20-eicosanediol, etc. Among these, ethylene glycol, 1,3-propanediol, 1,4-butanediol, 1,6-hexanediol, 1,9-nonanediol and 1,10-decanediol are preferably used in consideration of obtainability.

Specific examples of the branched-chain aliphatic diols having 2 to 36 carbon atoms include, but are not limited to 1,2-propyleneglycol, butanediol, hexanediol, octanediol, decanediol, dodecanediol, tetradecanediol, neopentylglycol, 2,2,-diethyl-1.3-propanediol, etc.

Specific examples of the alkylene ether glycols include, but are not limited to diethyleneglycol, triethyleneglycol, dipropyleneglycol, polyethyleneglycol, polypropyleneglycol, polytetramethyleneetherglycol, etc.

Specific examples of the alicyclic diols having 4 to 36 carbon atoms include, but are not limited to 1,4-cyclohexanedimethanol, hydrogenated bisphenol A, etc.

Specific examples of the alkylene oxides (AO) of the alicyclic diols include, but are not limited to ethylene oxide (EU), propylene oxide (PO), butylene oxide (BO), etc.

Specific examples of the bisphenols include, but are not limited to bisphenol A, bisphenol F, bisphenol S, etc.

Specific examples of the polylactone diols include, but are not limited to poly-ε-caprolactone diol, etc.

Specific examples of the diols having a carboxyl group include, but are not limited to dialkylolalkanic acids having 6 to 24 carbon atoms such as 2,2-dimethylolpropionic acid (DMPA), 2,2-dimethylolbutanic acid, 2,2-dimethylolheptanic acid and 2,2-dimethyloloctanic acid.

Specific examples of the diols having a sulfonic acid group or a sulfamic acid group include, but are not limited to N,N-bis(2-hydroxyethyl)sulfamic acid, and PO (2 mole) adducts of N,N-bis(2-hydroxyethyl)sulfamic acid, [N,N-bis(2-hydroxyalkyl(C1-C6))sulfamic acid, and AO (EU or PO) (1-6 moles) adducts of [N,N-bis(2-hydroxyalkyl(C1-C6))sulfamic acid; and bis(2-hydroxyethyl)phosphate.

Specific examples of neutralizing bases of these diols having a neutralizing base include, but are not limited to tertiary amines having 3 to 30 carbon atoms such as triethylamine and alkali metals such as a sodium salt.

Among these, alkylene glycol having 2 to 12 carbon atoms, diols having a carboxyl group, AO adducts of bisphenols and their combinations are preferably used.

Specific examples of the polyols having 3 to 8 or more valences include, but are not limited to alkanepolyols and their intramolecular or intermolecular dehydrated products such as glycerin, trimethylolethane, trimethylolpropane, pentaerythritol, sorbitol, sorbitan and polyglycerin; polyaliphatic alcohols having 3 to 36 carbons atoms and 3 to 8 or more valences such as sugars and their derivatives, e.g., sucrose, methylglucoside, etc.; AO (2-30 moles) adducts of trisphenols such as trisphenol PA; AO (2-30 moles) adducts of novolak resins such as phenol novolak and cresol novolak; acrylic polyols such as copolymers of hydroxyethyl(meth)acrylate and other vinyl monomers, etc. Among these, the polyaliphatic alcohols having 3 to 8 or more valences and AO adducts of novolak resins are preferably used, and the AO adducts of novolak resins are more preferably used.

Specific examples of the polycarboxylic acid include dicarboxylic acids and polycarboxylic acids having 3 to 6 or more valences.

Specific examples of the dicarboxylic acids include, but are not limited to aliphatic dicarboxylic acids such as straight-chain aliphatic dicarboxylic acids and branched-chain dicarboxylic acids; and aromatic dicarboxylic acids. Among these, the straight-chain aliphatic dicarboxylic acids are preferably used.

Specific examples of the aliphatic dicarboxylic acids include, but are not limited to alkanedicarboxylic acids having 4 to 36 carbon atoms such as a succinic acid, an adipic acid, a sebacic acid, an azelaic acid, a dodecanedicarboxylic acid, an octadecanedicarboxylic acid and a decylsuccinic acid; alkenylsuccinic acids such as a dodecenylsuccinic acid, a pentadecenylsuccinic acid and an octadecenylsuccinic acid; alkenedicarboxylic acids having 4 to 36 carbon atoms such as a maleic acid, a fumaric acid and a citraconic acid; and alicyclic dicarboxylic acids having 6 to 40 carbon atoms such as a dimer acid (dimeric linoleic acid).

Specific examples of the aromatic dicarboxylic acids include, but are not limited to aromatic dicarboxylic acids having 8 to 36 carbon atoms a such as a phthalic acid, an isophthalic acid, a terephthalic acid, a t-butyl isophthalic acid, a 2,6-naphthalene dicarboxylic acid and a 4,4′-biphenyldicarboxylic acid.

Specific examples of the polycarboxylic acid having 3 to 6 or more valences include aromatic polycarboxylic acids having 9 to 20 carbon atoms such as a trimellitic acid and a pyromellitic acid.

In addition, the above-mentioned acids anhydride or their lower alkyl esters having 1 to 4 carbon atoms such as methyl ester, ethyl ester and isopropyl ester may also be used.

Among these dicarboxylic acids, the aliphatic dicarboxylic acid (preferably the adipic acid, the sebacic acid, the dodecanedicarboxylic acid, the terephthalic acid or the isophthalic acid) is preferably used alone. Copolymers of the dicarboxylic acids and the aromatic dicarboxylic acids (preferably the terephthalic acid, the isophthalic acid, t-butyl isophthalic acid, and their lower alkyl esters) are preferably used as well. The copolymer preferably includes the aromatic dicarboxylic acid in amount not greater than 20 mol %.

Specific examples of the lactone ring-opening polymers include, but are not limited to lactone ring-opening polymers obtained by ring-opening polymerizing lactones, e.g., mono lactones having 3 to 12 carbon atoms (the number of ester groups in a ring is one) such as β-propiolactone, γ-butyrolactone, δ-valerolactone and ε-caprolactone with a catalyst such as metal oxides and organic metallic compounds; and lactone ring-opening polymers having a hydroxyl group at the end, obtained by ring-opening polymerizing mono lactones having 3 to 12 carbon atoms with glycol such as ethylene glycol and diethylene as an initiator.

Specific examples of the mono lactones having 3 to 12 carbon atoms include, but are not limited to ε-caprolactone, which is preferably used in terms of crystallinity.

Specific examples of marketed products of the lactone ring-opening polymers include high-crystallinity polycaprolactones such as PLACCEL series H1P, H4, H5 and H7 from Daicel Corp.

Specific examples of methods of preparing the polyhydroxy carboxylic acid include, but are not limited to a method of directly dehydrating and condensing polyhydroxy carboxylic acids such as a glycol acid and a lactic acid (L body, D body and racemic acid); and a method of ring-opening polymerizing a cyclic esters having 4 to 12 carbon atoms (2 to 3 ester groups in a ring) equivalent to bi or tri-intermolecular dehydrated and condensed products of hydroxy carboxylic acids such as glycolide and lactide with a catalyst such as metal oxides and organic metallic compounds. The method of ring-opening polymerizing is preferably used in terms of controlling a molecular weight.

L-lactide and D-lactide are preferably used as the cyclic esters in terms of crystallinity. These polyhydroxy carboxylic acids may be modified to have a hydroxyl group or a carboxyl group at the end.

The polyurethane resin is synthesized from diol or polyol having 3 to 8 or more valences and diisocyanate or polyisocyanate having 3 or more valences. Particularly, the polyurethane resin synthesized from diol and diisocyanate is preferably used.

Specific examples of the diol and polyol having 3 to 8 or more valences include those of the above-mentioned polyester resin.

Specific examples of the polyisocyanate include diisocyanate and polyisocyanate having 3 or more valences.

Specific examples of the diisocyanate include, but are not limited to aromatic diisocyanates, aliphatic diisocyanates, alicyclic diisocyanates and aromatic aliphatic diisocyanates. Among these, aromatic diisocyanates having 6 to 20 carbon atoms, aliphatic diisocyanates having 2 to 18 carbon atoms, alicyclic diisocyanates having 4 to 15 carbon atoms, aromatic aliphatic diisocyanates having 8 to 15 carbon atoms, their modified products including a urethane group, a carbodiimide group, an allophanate group, a urea group, a biuret group, a uretdione group, a uretimine group, an isocyanurate group, an oxazolidone group, etc., and their combinations. The number of the carbon atoms is those except for that thereof in NCO groups. Isocyanate having 3 or more valences may be combined when necessary.

Specific examples of the aromatic diisocyanates include, but are not limited to 1,3- and/or 1,4-phenylenediisocyanate, 2,4- and/or 2,6-trylenediisocyanate (TDI), crude TDI, 2,4- and/or 4,4-diphenylmethanediisocyanate (MDI), crude MDI (such as phosgene compounds of crude diaminophenyl methane (such as condensation products of formaldehyde and an aromatic amine (e.g., aniline) or a mixture including an aromatic amine, and mixtures of diaminodiphenylmethane and a small amount (about 5 to 20% by weight) of tri- or more-functional polyamine); and polyarylpolyisocyanate (PAPI)), 1,5-naphthylenediisocyanate, 4,4′,4″-triphenylmethanetriisocyanate, m- and p-isocyanatophenylsulfonylisocyanate, etc.

Specific examples of the aliphatic diisocyanates include, but are not limited to ethylenediisocyanate, tetramethylenediisocyanate, hexamethylenediisocyanate (HDI), dodecamethylenediisocyanate, 1,6,11-undecanetriisocyanate, 2,2,4-trimethylhexamethylenediisocyanate, lysinediisocyanate, 2,6-diisocyanatomethylcaproate, bis(2-isocyanatoethyl)fumarate, bis(2-isocyanatoethyl)carbonate, 2-isocyanatoethyl-2,6-diisocyanatohexanoate, etc.

Specific examples of the salicylic diisocyanates include, but are not limited to isophoronediisocyanate (IPDI), dicyclohexylmethane-4,4-diisocyanate (hydrogenated MDI), cyclohexylenediisocyanate, methylcyclohexylenediisocyanate (hydrogenated TDI), bis(2-isocyanatoethyl)-4-cyclohexene-1,2-dicarboxylate, 2,5- and 2,6-norbornanediisocyanate, etc.

Specific examples of the aromatic aliphatic diisocyanates include, but are not limited to m- and p-xylylenediisocyanate (XDI), α,α,α′,α′,-tetramethylxylylenediisocyanate (TMXDI), etc.

Specific examples of the modified products of the diisocyanates include, but are not limited to modified products including a urethane group, a carbodiimide group, an allophanate group, a urea group, a biuret group, a uretdione group, a uretimine group, an isocyanurate group, an oxazolidone group, etc. Specifically, modified MDIs such as urethane-modified MDI, carbodiimide-modified MDI and trihydrocarvylphosphate-modified MDI; urethane-modified TDI such as a prepolymer including isocyanate; and their mixtures such as a mixture of the modified MDI and the urethane-modified TDI can be used.

Among these diisocyanates, aromatic diisocyanates having 6 to 15 carbon atoms, aliphatic diisocyanates having 4 to 12 carbon atoms, alicyclic diisocyanates having 4 to 15 carbon atoms are preferably used (the number of the carbon atoms are those except for that thereof in NCO groups), and TDI, MDI, HDI, hydrogenated MDI and IPDI are more preferably used.

The polyurea resin is synthesized from diamine or polyamine having 3 or more valences and diisocyanate or polyisocyanate having 3 or more valences. Particularly, the polyurea resin synthesized from diamine and diisocyanate is preferably used. Specific examples of the diisocyanate and the polyisocyanate having 3 or more valences include those of the above-mentioned polyurethane resin.

The polyamine includes diamine and polyamine having 3 ore more valences. Specific examples of the diamine include, but are not limited to aliphatic diamines and aromatic diamines. Among these, aliphatic diamines having 2 to 18 carbon atoms and aromatic diamines having 6 to 20 carbon atoms are preferably used. Amines having 3 ore more valences may be used when necessary.

Specific examples of the aliphatic diamines having 2 to 18 carbon atoms include, but are not limited to alkylene diamines having 2 to 6 carbon atoms such as ethylenediamine, propylenediamine, trimethylenediamine, tetramethylenediamine and hexamethylenediamine; polyalkylene diamines having 4 to 18 carbon atoms such as diethylenetriamine, iminobispropylamine, bis(hexamethylene)triamine, triethylenetetramine, tetraethylenepentamine and pentaethylenehexamine; alkyl (C1-C4) or hydroxyalkyl (C2-C4) substituents of the alkylene diamines and the polyalkylene diamines such as dialkylaminopropylaminc, trimethylhexamethylenediamine, aminoethylethanolamine, 2,5-dimethyl-2,5-hexamethylenediamine and methyliminobispropylamine; alicyclic diamines having 4 to 15 carbon atoms such as 1,3-diaminocyclohexane, isophoronediamine, mencenediamine and 4,4′-methylenedicyclohexanediamine (hydrogenated methylenedianiline); heterocyclic diamines having 4 to 15 carbon atoms such as piperazine, N-aminoethylpiperazine, 1,4-diaminoethylpiperazine, 1,4-bis(2-amino-2-methylpropyl)piperazine, 3,9-bis(3-aminopropyl)-2,4,8,10-tetraoxaspiro[5,5]undecane; aliphatic amines (C8-C15) including an aromatic ring such as xylylenediamine and tetrachlor-p-xylylenediamine.

Specific examples of the aromatic diamines having 6 to 20 carbon atoms include, but are not limited to unsubstituted aromatic diamines such as 1,2-, 1,3- and 1,4-phenylenediamine, 2,4′- and 4,4′-diphenylmethanediamnine, crude diphenylmethanediamine (polyphenylpolymethylenepolyamine), diaminophenylsulfone, benzidine, thiodianiline, bis(3,4-diaminophenyl)sulfone, 2,6-diaminopyridine, m-aminobenzylamine, triphenylmethane-4.4′,4″-triamine and naphthylenediamine; aromatic diamines (C1-C4) having a nuclear-substituted alkyl group such as 2,4- and 2,6-tolylenediamine, crude tolylenediamine, diethyltolylenediamine, 4,4′-diamino-3,3′-dimethyldiphenylmethane, 4,4′-bis(o-toluidine), dianisidine, diaminoditolylsulfone, 1,3-dimethyl-2,4-diaminobenzene, 1,3-dimethyl-2,6-siaminobenzene, 1,4-diisopropyl-2,5-diaminobenzene, 2,4-diaminomesitylene, 1-methul-3,5-diethyl-2,4-diaminobenzne, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenylmethane, 3,5-diethyl-3′-methyl-2′,4-diaminophenylmethane, 3,3-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraethyl-4,4′-diaminodiphenylether and 3,3′,5,5′-tetraisopropyl-4,4′-diaminodiphenylsulfone; mixtures of isomers of the unsubstituted aromatic diamines or the aromatic diamines (C1-C4) having a nuclear-substituted alkyl group in various ratios; aromatic diamines having a nuclear-substituted electron withdrawing group (halogens such as Cl, Br and I, alkoxy groups such as a methoxy group and an ethoxy group and a nitro group) such as methylenebis-o-chloroaniline, 4-chloro-o-phenylenediamine, 2-chlor-1,4-phenylenediamine, 3-amino-4-chloroaniline, 4-bromo-1,3-phenylenediamine, 2,5-dichlor-1,4-phenylenediamine, 5-nitro-1,3-phenylenediamine, 3-dimethoxy-4-aminoaniline, 4,4′-diamino-3,3′-dimethyl-5,5′-dibromo-diphenylmethane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl) sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylenebis(2-iodineaniline), 4,4′-methylenebis(2-bromoaniline), 4,4′-methylenebis(2-fluoroaniline) and 4-aminophenyl-2-chloroaniline; and aromatic diamines having a secondary amino group [the unsubstituted aromatic diamines, the aromatic diamines (C1-C4) having a nuclear-substituted alkyl group, the mixtures of isomers thereof in various ratios and the aromatic diamines having a nuclear-substituted electron withdrawing group, the primary amino groups of which are partly or totally substituted with secondary amino groups by lower alkyl groups such as methyl and ethyl] such as 4,4′-di(methylamino)diphenylmethane and 1-methyl-2-methylamino-4-aminobenzne.

Besides these, polyamide polyamine such as low-molecular-weight polyamide polyamine obtained from condensation between a dicarboxylic acid such as a dimeric acid and the excessive (2 mol or more per 1 mol of an acid) polyamine such as alkylenediamine and polyalkylenepolyamine; and polyether polyamine such as hydrogenated products of cyano ethylated polyetherpolyol such as polyalkyleneglycol can also be used.

The polyamide resin is synthesized from diamine or polyamine having 3 or more valences and dicarboxylic acid or polycarboxylic acid having 3 to 6 or more valences. The polyamide resin synthesized from the diamine and the dicarboxylic acid is preferably used.

Specific examples of the diamine and the polyamine having 3 or more valences include those of the above-mentioned polyurea resin.

Specific examples of the dicarboxylic acid and the polycarboxylic acid having 3 to 6 or more valences include those of the above-mentioned polyester resin.

Specific examples of the polyether resin include, but are not limited to crystalline polyoxyalkylenepolyol.

Specific examples of methods of preparing the crystalline polyoxyalkylenepolyol include, but are not limited to a method of ring-opening polymerizing chiral AO with a catalyst typically used in polymerizing AO (disclosed on pages 4,787 to 4,792 in No. 18 vol. 78 of Journal of the American Chemical Society published in 1956), or inexpensive racemic AO using a complex having a specific dimensionally bulky chemical structure as a catalyst. As methods of using a specific complex, Japanese published unexamined application No. 11-12353 disclose a method of using a compound obtained from contacting a lanthanoid complex with organic aluminum as a catalyst and Japanese published unexamined application No. 2001-521957 discloses a method of preliminarily reacting bimetalμi-oxoalkoxide with a hydroxyl compound.

As a method of obtaining the crystalline polyoxyalkylenepolyol having very high isotacticity, pages 11,566 to 11,567 in No. 33 vol. 127 of Journal of the American Chemical Society published in 2005 discloses a method of using salen as a catalyst. When ring-opening polymerizing chiral AO, glycol or water is used as an initiator to obtain polyoxyalkyleneglycol having a hydroxyl group at the end and isotacticity not less than 50%. The polyoxyalkyleneglycol having isotacticity not less than 50% may be modified to have a carboxyl group at the end. When the polyoxyalkyleneglycol has isotacticity not less than 50%, it typically has crystallinity. The diols can be used as the glycol, and the dicarboxylic acids can be used as the carboxylic acid used for modifying.

The AO used for preparing the crystalline polyoxyalkylenepolyol have 3 to 9 carbon atoms, and specific example thereof include PO, 1-chlorooxetane, 2-chlorooxetane, 1,2-dichlorooxetane, epichlorohydrin, 1,2-BO, methylglycidylether, 1,2-pentyleneoxide, 2,3-pentyleneoxide, 3-methyl-1,2-butyleneoxide, cyclohexeneoxide, 1,2-hexyleneoxide, 3-methyl-1,2-pentyleneoxide, 2,3-hexyleneoxide, 4-methyl-2,3-pentyleneoxide, allylglycidylether, 1,2-heptyleneoxide, styreneoxide, phenylglycidylether, etc. Among these AOs, PO, 1,2-BO, styreneoxide and cyclohexeneoxide are preferably used, and PO, 1,2-BO and cyclohexeneoxide are more preferably used. These can be used alone or in combination.

The crystalline polyoxyalkylenepolyol preferably has isotacticity not less than 70%, more preferably not less than 80%, furthermore preferably not less than 90%, and most preferably not less than 95% in terms of sharp meltability and anti-blocking of the resultant crystalline polyether resin.

The isotacticity is measured by a method disclosed on pages 2,389 to 2392 in No. 6 vol. 35 of Macromolecules published in 2002 as follows.

About 30 mg of a sample is placed in a test tube having a diameter of 5 mm for ¹³C-NMR, and dissolved with about 0.5 ml of a deuterated solvent to prepare a sample for analysis. Specific examples of the deuterated solvent include, but are not limited to deuterated chloroform, deuterated toluene, deuterated dimethylsulfoxide, deuterated dimethylformamide, etc. Three methine-group-originated signals of ¹³C-NMR are observed at around a syndiotactic value (S) 75.1 ppm, a heterotactic value (H) 75.3 ppm and an isotactic value (I) 75.5 ppm, respectively.

The isotacticity is determined by the following formula (1):

Isotacticity (%)=[I/(I+S+H)]×100 (1)

wherein I is an integral value of the isotactic signal, S is an integral value of the syndiotactic signal and H is an integral value of the heterotactic signal.

Specific example of the vinyl resin include, but are not limited to vinyl resins formed of crystalline vinyl monomer and vinyl monomer having no crystallinity.

Specific example of the crystalline vinyl monomer include, but are not limited to straight-chain alkyl(meth)acrylate in which the alkyl group has 12 to 50 carbon atoms (the straight-chain alkyl group having 12 to 50 carbon atoms is a crystalline group) such as lauryl(meth)acrylate, tetradecyl(meth)acrylate, stearyl(meth)acrylate, eicosyl(meth)acrylate and behenyl(meth)acrylate.

Specific example of the crystalline vinyl monomer include, but are not limited to vinyl monomers having a molecular weight not greater than 1,000 such as styrenes, (meth)acrylic monomers, vinyl monomers including a carboxyl group, other vinylester monomers and aliphatic hydrocarbon vinyl monomers. These can be used alone or in combination.

Specific examples of the styrenes include, but are not limited to styrene, alkylstyrene in which the alkyl group has 1 to 3 carbon atoms.

Specific example of the(meth)acrylic monomers include, but are not limited to alkyl(meth)acrylate in which the alkyl group has 1 to 11 carbon atoms and branched alkyl(meth)acrylate in which the alkyl group has 12 to 18 carbon atoms such as methyl(meth)acrylate, ethyl(meth)acrylate, butyl(meth)acrylate and 2-ethylhexyl(meth)acrylate; hydroxylalkyl(meth)acrylate in which the alkyl group has 1 to 11 carbon atoms such as hydroxylethyl(meth)acrylate; and (meth)acrylate including an alkylamino group, in which the alkyl group has 1 to 11 carbon atoms such as dimethylaminoethyl(meth)acrylate and diethylaminoethyl(meth)acrylate.

Specific example of the vinyl monomer including a carboxyl group include, but are not limited to monocarboxylic acids having 3 to 15 carbon atoms such as (meth)acrylic acid, crotonic acid and cinnamic acid; dicarboxylic acids having 4 to 15 carbon atoms such as maleic acid anhydride, fumaric acid, itaconic acid and citraconic acid; and dicarboxylic acid monoester such as monoalkyl(C1-C18) ester of the dicarboxylic acid such as monoalkylester maleate, monoalkylester fumarate, monoalkylester itaconate and monoalkylester citraconate.

Specific example of the other vinyl ester monomer include, but are not limited to aliphatic vinyl esters having 4 to 15 carbon atoms such as vinylacetate, vinylpropionate and isopropenylacetate; unsaturated carboxylic acid multivalent (2 to 3 ore more valences) alcohol esters (C8-C30) such as ethyleneglycoldi(meth)acrylate, propyleneglycoldi(meth)acrylate, neopentylglycoldi(meth)acrylate, trimethylolpropanetri(meth)acrylate, 1,6-hexanedioldiacrylate and polyethyleneglycol di(meth)acrylate; and aromatic vinyl esters having 9 to 15 carbon atoms such as methyl-4-vinylbenzoate.

Specific example of the aliphatic hydrocarbon vinyl monomers include, but are not limited to olefins having 2 to 10 carbon atoms such as ethylene, propylene, butene and octene; and diene having 4 to 10 carbon atoms such as butadiene, isoprene and 1,6-hexadiene.

Specific example of the modified crystalline resin include, but are not limited to crystalline resins having a functional group reactable with an active hydrogen group such as a crystalline polyester resin, a crystalline polyurethane resin, a crystalline polyurea resin, a crystalline polyamide resin, a crystalline polyether resin and a crystalline vinyl resin having a functional group reactable with an active hydrogen group. The modified crystalline resin reacted with a compound having an active hydrogen group such as a resin having an active hydrogen group, a crosslinker or an elongator having an active hydrogen group polymerizes a resin to form a binder resin in the process of preparing a toner. Therefore, the modified crystalline resin can be used as a binder resin precursor in preparation of a toner.

The binder resin precursor is a monomer or an oligomer forming the binder resin, a modified resin having a functional group reactable with the active hydrogen group, or a compound elongatable or crosslinkable compound including oligomers, which may be a crystalline resin or an amorphous resin. The binder resin precursor is preferably the modified crystalline resin having an isocyanate group at the end, and preferably forms a binder resin through an elongation or a crosslinking reaction with an active hydrogen group when dispersed or emulsified in an aqueous medium. The binder resin formed from the binder resin precursor is preferably a crystalline resin formed from an elongation or a crosslinking reaction between the modified resin having a functional group reactable with an active hydrogen group and the compound having an active hydrogen group. Particularly, a urethane-modified polyester resin formed from an elongation or a crosslinking reaction between a polyester resin having an isocyanate group at the end and the polyol, and a urea-modified polyester resin formed from an elongation or a crosslinking reaction between a polyester resin having an isocyanate group at the end and amines are preferably used.

Specific examples of the functional group reactable with an active hydrogen group include, but are not limited to functional groups such as an isocyanate group, an epoxy group, a carboxylic acid and acid chloride groups. Among these, the isocyanate group is preferably used.

Specific examples of the compound having an active hydrogen group include, but are not limited to compounds having a hydroxyl group (an alcoholic hydroxyl group and a phenolic hydroxylic group), an amino group, a carboxyl group or a mercapto group as the active hydrogen group when functional group reactable with an active hydrogen group is an isocyanate group. Among these, the compounds having an amino group, i.e., amines are preferably used.

Specific examples of the amines include, but are not limited to phenylene diamine, diethyltoluene diamine, 4,4′-diaminodiphenyl methane, 4,4′-diamino-3,3′-dimethyldicyclohexyl methane, diaminocyclohexane, isophoronediamine, ethylene diamine, tetramethylene diamine, hexamethylene diamine, diethylene triamine, triethylene tetramine, ethanol amine, hydroxyethyl aniline, aminoethyl mercaptan, aminopropyl mercaptan, amino propionic acid, amino caproic acid, etc. In addition, ketimine compounds, oxazoline compounds, etc, which are prepared by blocking the amino groups of the amines with ketones such as acetone, methyl ethyl ketone and methyl isobutyl ketone can also be used.

The amines include amino groups [NHx] not greater than 4 times, preferably not greater than 2 times, more preferably not greater than 1.5 times, and furthermore preferably not greater than 1.2 times as isocyanate groups [NCO] in the modified crystalline resin having an isocyanate group in number. When greater than 4 times, the excessive amino groups blocks isocyanate and the modified resin is not elongated.

The crystalline resin may be a blocked resin having a crystallinity part and an amorphousness part, and the crystalline resin can be used for crystallinity part. Specific examples of resins used for the amorphousness part include, but are not limited to a polyester resin, a polyurethane resin, a polyurea resin, a polyamide resin, a polyether resin, vinyl resins such as polystyrene and styrene acrylic polymers, an epoxy resin, etc.

However, the polyester resin, the polyurethane resin, the polyurea resin, the polyamide resin and the polyether resin are preferably used for the crystallinity part, and these and their complex resins are preferably used, and the polyurethane resin and the polyester resin are more preferably used for the amorphousness part in terms of compatibility. Specific examples of monomer compositions of the amorphousness part include, but are not limited to the polyol, the polycarboxylic acid, the polyisocyanate, the polyamine, the AO, etc.

Two or more crystalline resins can be used, and a combination of a first crystalline resin and a second crystalline resin having a weight-average molecular weight larger than that of the first crystalline resin expands a molecular weight distribution of the resultant toner. A low-molecular-weight resin improves impregnation thereof to a paper and a polymeric resin prevents the hot offset. The modified crystalline resin may be used as the second crystalline resin to be elongated or crosslinked in the process of a toner.

Specific examples of the amorphous resins include, but are not limited to a monomer of styrene and its derivative such as polystyrene, poly-p-styrene and polyvinyltoluene; a styrene copolymer such as styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleate copolymer; poly(methyl methacrylate), poly(butyl methacrylate), polyvinylchloride, polyvinyl acetate, polyethylene, polyester, polyurethane, epoxy resin, polyvinyl butyral, poly(acrylic acid), rosin, modified rosin, terpene resin, phenolic resin, aliphatic or aromatic hydrocarbon resin, aromatic petroleum resin etc., and their modified resins to have a functional group reactable with an active hydrogen group. These can be used alone or in combination.

Specific examples of the colorants for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELM BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These can be used alone or in combination.

Specific examples of color of the colorants include, but are not limited to black, magenta, cyan, yellow, etc. These can be used alone or in combination.

Specific examples of black color colorants include carbon blacks (C.I. Pigment Black 7) such as furnace black, lamp black, acetylene black and channel black; metals such as copper, iron (C.I. Pigment Black 11) and titanium oxide; and an organic pigment such as aniline black (C.I. Pigment Black 1), etc.

Specific examples of magenta color colorants include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209 and 211; C.I. Pigment Violet 19; and C.I. Vat Red 1, 2, 10, 13, 15, 23, 29 and 35.

Specific examples of cyan color colorants include C.I. Pigment Blue 2, 3, 15, 15:1, 15:2, 15:3, 15:4, 15:6, 16, 17 and 60; C.I. Vat Blue 6; C.I. Acid Blue 45; copper phthalocyanine pigment in which the phthalocyanine skeleton substituted with 1 to 5 phthalimide methyl groups; and Green 7 and Green 36.

Specific examples of yellow color colorants include C.I. Pigment Yellow 0-16, 1, 2, 3, 4, 5, 6, 7, 10, 11, 12, 13, 14, 15, 16, 17, 23, 55, 65, 73, 74, 83, 97, 110, 151, 154 and 180; C.I. Vat yellow 1,3 and 20; and Orange 36.

The toner preferably includes the colorant in an amount of from 1 to 15% by weight, and more preferably from 3 to 10% by weight. When less than 1% by weight, the toner deteriorates in colorability. When greater than 15% by weight, the colorant is not sufficiently dispersed in the toner, resulting in deterioration of the colorability and chargeability.

The colorant may be combined with a resin to be used as a masterbatch. Specific examples of the resin include, but are not limited to styrene polymers and substituted styrene polymers, styrene copolymers, a polymethyl methacrylate resin, a polybutylmethacrylate resin, a polyvinyl chloride resin, a polyvinyl acetate resin, a polyethylene resin, a polypropylene resin, a polyester resin, an epoxy resin, an epoxy polyol resin, a polyurethane resin, a polyamide resin, a polyvinyl butyral resin, an acrylic resin, rosin, modified rosin, a terpene resin, an aliphatic or an alicyclic hydrocarbon resin, an aromatic petroleum resin, chlorinated paraffin, paraffin, etc. These resins are used alone or in combination.

Specific examples of the styrene polymers and substituted styrene polymers include a polyester resin, a polystyrene resin, a poly-p-chlorostyrene resin and a polyvinyltoluene resin. Specific examples of the styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers, etc.

The masterbatch can be prepared by mixing and kneading a resin and a colorant upon application of high shearing stress thereto. In this case, an organic solvent is preferably used to increase interactions between the colorant and the resin. In addition, flushing methods, wherein an aqueous paste including a colorant is mixed with a resin solution of an organic solvent to transfer the colorant to the resin solution and then the aqueous liquid and organic solvent are separated and removed, is preferably used because the resultant wet cake of the colorant can be used as it is. A three roll mill is preferably used for kneading the mixture upon application of high shearing stress.

The toner of the present invention may include a release agent when necessary. The release agent is not particularly limited, and known release agents can be used. Specific examples thereof include waxes including a carbonyl group, polyolefin waxes, long-chain hydrocarbons, etc. Among these, waxes including a carbonyl group are preferably used.

Specific examples of the waxes including a carbonyl group include ester polyalkanates such as a carnauba wax, a montan wax, trimethylolpropanetribehenate, pentaerythritoltetrabehenate, pentaerythritoldiacetatedibehenate, glycerinetribehenate, and 1,18-octadecanedioldistearate; polyalkanolesters such as tristearyltrimelliticate and distearylmaleate; amide polyalkanates such as ethylenediaminedibehenylamide; polyalkylamides such as tristearylamidetrimelliticate; and dialkylketones such as distearylketone. Among these waxes including a carbonyl group, the ester polyalkanates are preferably used.

Specific examples of the polyolefin waxes include polyethylene waxes and polypropylene waxes.

Specific examples of the long chain hydrocarbons include paraffin waxes and sasol waxes.

The release agent preferably has a melting point of from 40 to 160° C., more preferably from 50 to 120° C., and most preferably from 60 to 90° C. When less than 40° C., the resultant toner occasionally deteriorates in hest-resistant storage stability. When higher than 160° C., the resultant toner occasionally deteriorates in cold offset resistance. The melting point of the release agent can be measured by a differential scanning calorimeter DSC-210 from Seiko Instruments Inc., in which a sample is heated up to 200° C., cooled to 0° C. at 10° C./min, and heated at 10° C./min to determine a maximum peak temperature of the melting heat as the melting point.

The release agent preferably has a melting viscosity of from 5 to 1,000 cps, and more preferably from 10 to 100 cps at a temperature 20° C. higher than the melting point. When less than 5 cps, the resultant toner occasionally deteriorates in releasability. When greater than 1,000 cps, the resultant toner occasionally deteriorates in hot offset resistance and low-temperature fixability.

The toner preferably includes the release agent in an amount of from 0 to 40%, and more preferably from 3 to 30% by weight. When greater than 40% by weight, the resultant toner occasionally deteriorates in fluidity.

The toner of the present invention may include a charge controlling agent when necessary. The charge controlling agents is not particularly limited, and known charge controlling agents can be used. However, colorless or whity agents are preferably used because colored agents occasionally charge the color tone of the resultant toner. Specific examples thereof include triphenylmethane dyes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid and its derivatives, etc. These can be used alone or in combination.

Specific examples of the marketed products of the charge controlling agents include BONTRON P-51 (quaternary ammonium salt), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The charge controlling agent may be melted and kneaded with the masterbatch, and dissolved or dispersed, dissolved or dispersed in an organic solvent with other toner materials, or fixed on the surface of a toner after prepared.

The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large charge quantity, and thereby the electrostatic force of a developing roller attracting the toner increases, resulting in deterioration of the fluidity of the toner and decrease of the image density of toner images.

The toner of the present invention may include an external additive when necessary. Specific examples of the external additives include Specific examples of the external additives include particulate silica, hydrophobized particulate silica, fatty acid metallic salts such as zinc stearate and alumina stearate; metal oxides or hydrophobized metal oxides such as particulate titania, alumina, tin oxide and antimony oxide; fluoropolymers, etc. Among these external additives, the hydrophobized particulate silica, hydrophobized particulate titania and hydrophobized particulate alumina are preferably used.

Specific examples of the particulate silica include HDK H 2000, HDK H 2000/4, HDK H 2050EP, HVK21 and HOK H1303 from Hoechst AG; and R972, R974, RX200, RY200, R202, R805 and R812 from Nippon Aerosil Co. Specific examples of the particulate titania include P-25 from Nippon Aerosil Co.; STT-30 and STT-65C-S from Titan Kogyo K.K.; TAF-140 from Fuji Titanium Industry Co., Ltd.; MT150W, MT-500B, MT-600B and Mt-150A from Tayca Corp., etc. Specific examples of the particulate hydrophobized titanium oxide include T-805 from Nippon Aerosil Co.; STT-30A and STT-65S-S from Titan Kogyo K. K.; TAF-500T and TAF-1500T from Fuji Titanium Industry Co., Ltd.; MT-100S and MT100T from Tayca Corp.; IT-S from Ishihara Sangyo Kaisha Ltd., etc.

To prepare the particulate hydrophobized silica, titania or alumina, a hydrophilic particulate material is subjected to silane coupling agents such as methyltrimethoxy silane, methyltriethoxy silane and octylmethoxy silane.

An inorganic particulate material optionally subjected to a silicone oil upon application of heat is preferably used as well.

Specific examples of the silicone oil include dimethyl silicone oil, methylphenyl silicone oil, chlorphenyl silicone oil, methylhydrogen silicone oil, alkyl modified silicone oil, fluorine modified silicone oil, polyether modified silicone oil, alcohol modified silicone oil, amino modified silicone oil, epoxy modified silicone oil, epoxy-polyether modified silicone oil, phenol modified silicone oil, carboxyl modified silicone oil, mercapto modified silicone oil, acryl modified silicone oil, methacryl modified silicone oil, α-methylstyrene modified silicone oil, etc.

Specific examples of the inorganic particulate material include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc. Particularly, the silica and titanium dioxide are preferably used.

The toner preferably includes the external additives in an amount of from 0.1 to 5% by weight and more preferably from 0.3 to 3% by weight.

The inorganic particulate material preferably has an average primary particle diameter not greater than 100 nm, and more preferably of from 3 to 70 nm. When less than 3 nm, the inorganic particulate material is buried in the toner. When greater than 100 nm, the surface of a photoreceptor is damaged.

As the external additive, the inorganic particulate material and a hydrophobized inorganic particulate material can be used together. It is preferable to externally include at least one hydrophobized inorganic particulate material having an average primary particle diameter of from 1 to 100 nm, and more preferably from 5 to 70 nm. Further, it is more preferable to include at least one hydrophobized inorganic particulate material having an average primary particle diameter not greater than 20 nm and an inorganic particulate material having an average primary particle diameter not less than 30 nm. The external additive preferably has a specific surface area of from 20 to 500 m²/g when measured by a BET method.

Specific examples of surface treatment agents for external additives including the oxidized particulate materials include silane coupling agents such as dialkyldihalogenated silane, trialkylhalogenated silane, alkyltrihalogenated silane and hexaalkyldisilazane; silylation agents; silane coupling agents having a fluorinated alkyl group; organic titanate coupling agents; aluminum coupling agents; silicone oil; and silicone varnish.

Particulate resins can be used together as the external additives. Specific examples thereof include polystyrene formed by a soap-free emulsifying polymerization, a suspension polymerization or a dispersing polymerization; estermethacrylate or esteracrylate copolymers; polycondensed particulate materials such as silicone resins, benzoguanamine resins and nylon; and particulate polymers of thermosetting resins. The particulate resins combined with the other external additives improve chargeability of the resultant toner, and reduce a reversely-charged toner to decrease background fouling. The toner preferably includes the particulate resin in an amount of from 0.01 to 5% by weight, and more preferably from 0.1 to 2.0% by weight.

A fluidity improver improves hydrophobicity of the toner by surface-treatment and prevents deterioration of fluidity and chargeability thereof even at high humidity. Specific examples there of include silane coupling agents, sililating agents, silane coupling agents having an alkyl fluoride group, organic titanate coupling agents, aluminium coupling agents silicone oils and modified silicone oils.

A cleanability improver is used to easily remove a toner remaining on a photoreceptor and a first transferer after transferred. Specific examples thereof include fatty acid metallic salts such as zinc stearate, calcium stearate and stearic acid; and particulate polymers prepared by a soap-free emulsifying polymerization method such as particulate polymethylmethacrylatc and particulate polystyrene. The particulate polymers comparatively have a narrow particle diameter distribution and preferably have a volume-average particle diameter of from 0.01 to 1 μm.

Specific examples of a magnetic material include, but are not limited to iron powder, magnetite, ferrite, etc.

The toner of the present invention by a solution suspension method granulating a toner material liquid in an aqueous medium, and an aggregation method aggregating and melting s toner material including at least ac crystalline resin in an aqueous medium. The former method is preferably used in terms of resin uniformity.

Toner materials such as a colorant, a resin and a release agent are dispersed or dissolved in an organic solvent to prepare a toner material liquid. The colorant, the resin and the release agent may separately be dispersed or dissolved in an organic solvent and mixed.

The organic solvent is preferably a volatile solvent having a boiling point less than 100° C. because of being easily removed after a toner particle is formed. Specific examples of the organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, methyl ethyl ketone and methyl isobutyl ketone. These can be used alone or in combination. Particularly, aromatic solvents such as the toluene and xylene and halogenated hydrocarbons such as the methylene chloride, 1,2-dichloroethane, chloroform and carbon tetrachloride. A content of the organic solvent is typically from 0 to 300 parts by weight, preferably from 0 to 100 parts by weight, and more preferably from 25 to 70 parts by weight per 100 parts by weight of the toner materials.

Next, the toner material liquid is emulsified in an aqueous medium in the presence of a surfactant and a particulate resin.

The aqueous medium may include water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

The content of the water medium is typically from 50 to 2,000 parts by weight, and preferably from 100 to 1,000 parts by weight per 100 parts by weight of the toner constituent liquid. When the content is less than 50 parts by weight, the toner constituent liquid is not well dispersed and a toner particle having a predetermined particle diameter cannot be formed. When the content is greater than 2,000 parts by weight, the production cost increases.

A dispersant such as a surfactant and particulate resin is optionally included in the aqueous medium to improve the dispersion therein.

Specific examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium-{omega-fluoroalkanoyl(C6-C8)-N-ethylamino}-1-propanesulfonate, fluoroalkyl(C11-C20) carboxylic acids and their metal salts, perfluoroalkylcarboxylic acids (C7-C13) and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 123B, 306A, 501, 201 and 204, which are manufactured by Tohchem Products Co., Ltd.; FUTARGENT F-100 and F150 manufactured by Neos; etc.

Specific examples of cationic surfactants include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Specific examples of the particulate resin include any thermoplastic and thermosetting resins capable of forming a dispersion element such as vinyl resins, a polyurethane resin, an epoxy resin, a polyester resin, a polyamide resin, a polyimide resin, silicon resins, a phenol resin, a melamine resin, a urea resin, an aniline resin, an ionomer resin, a polycarbonate resin, etc. These resins can be used alone or in combination.

Among these resins, the vinyl resins, the polyurethane resin, the epoxy resin, the polyester resin and their combinations are preferably used in terms of forming an aqueous dispersion of microscopic spherical particulate resins. Specific examples of the vinyl resins include homopolymerized or copolymerized polymers such as styrene-(metha)esteracrylate resins, styrene-butadiene copolymers, (metha)acrylic acid-esteracrylate polymers, styrene-acrylonitrile copolymers, styrene-maleic acid anhydride copolymers and styrene-(metha)acrylic acid copolymers. The particulate resin preferably has an average particle diameter of from 5 to 200 nm, and more preferably from 20 to 300 nm. Inorganic compound dispersants such as tricalcium phosphate, calcium carbonate, titanium oxide, colloidal silica and hydroxyapatite, etc. can be used as well.

A polymeric protective colloid can be used as a dispersant with the particulate resin and the inorganic compound dispersants. Specific examples thereof include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyalkylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 min. The temperature in the dispersion process is typically from 0 to 150° C. (under pressure), and preferably from 40 to 98° C.

In order to remove the organic solvent from the aqueous (resin) dispersion of the toner material liquid, the aqueous dispersion is gradually heated while stirred to completely vapor the organic solvent therefrom.

Alternatively, the aqueous (resin) dispersion is sprayed in a dried atmosphere while stirred to remove the organic solvent in the droplet. Or, the aqueous (resin) dispersion is depressurized while stirred to vapor the organic solvent therefrom. These two methods can be used together with the first method.

The air, nitrogen gas, carbonate gas and combustion gas, particularly heated to have a temperature higher than its boiling point us typically used as the dried atmosphere the aqueous (resin) dispersion is sprayed in. A spray drier, a belt drier or a rotary kiln is used to vapor the solvent in s short time.

When a modified resin having an isocyanate group at the end is used, there may be an aging process to promote elongation or crosslinking reaction of the isocyanate. The aging time is typically from 10 min to 40 hrs, and preferably from 2 to 24 hrs. The reaction temperature is typically from 0 to 40° C., and preferably from 15 to 30° C.

The resin includes side materials such as a surfactant and a dispersant, and is washed to remove these as well as a high-polarity material present on the surface of the particulate resin. This prevents methanol wettability of the toner.

The high-polarity material includes a surfactant, a particulate resin, a dispersant, etc., which are thought to partly adhere or adsorb to the surface of the resin or partly penetrate inside thereof. These are effectively removed when heated with an acid or an alkaline. Particularly when the high-polarity material is ionic, ionic dissociation is preferably made. An alkaline is preferably used to remove particulate resins having an anionic surfactant, a carboxylic group or a sulfonic acid group, and an acid is preferably used to remove dispersants such as calcium phosphate. The alkaline preferably has 9 to 13 pH, more preferably from 9.5 to 12 pH, and furthermore preferably from 10 to 11 pH. When less than 9 pH, the resin is not effectively washed. When greater than 13 pH, the resin is possibly hydrolyzed.

The maximum heating temperature is less than a melting point of the crystalline resin. When greater than the melting point, the resin molecule executes free thermal motion and is vulnerable to alkaline attack, resulting in decrease of molecular weight and deterioration o heat-resistant storage stability. The minimum heating temperature is preferably not less than 30° C., more preferably not less than 40° C., and furthermore preferably not less than 45° C. When less than 30° C., the resin is not effectively washed. The resin is heated for at least 30 min, preferably not less than 2 hrs, more preferably not less than 5 hrs, and furthermore preferably not less 10 hrs. When less than 30 min, the resin is not effectively washed. This is thought to be effective to remove a polymeric high-polarity material.

The above-mentioned process may be performed after washing with ion-exchanged water, or before the aging process after washing with ion-exchanged water.

After the above-mentioned process, washing with ion-exchanged water is preferably performed and with an acid. This is thought to close even a small amount if remaining acidic functional group with proton.

An aqueous solvent including a dissolved or a dispersed fluorine compound may be added in the washing process to be transferred or ion-bonded to the surface of the toner. This may be performed at any time in the washing process, but is preferably performed after subjected to an acid because the fluorine compound is effectively transferred or ion-bonded to the surface thereof.

The fluorine compound increases chargeability of the toner, decreases toner spent on a carrier even when several tens of thousands of images are produced, and maintains high chargeability and fluidity thereof.

Specific examples of the fluorine compound include any organic and inorganic fluorine compounds as long as they include a fluorine atom. A fluorine compound having the following formula (I) is preferably used.

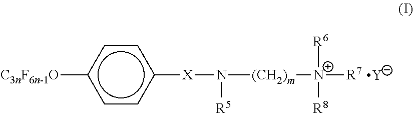

wherein X represents SO₂ or CO; R⁵, R⁶, R⁷ and R⁸ individually represent H, an alkyl group or aryl group having 1 to 10 carbon atoms; m and n represent integers; and Y represents a halogen atom such as I and BrCl.

The charge controlling agent is preferably a combination of a fluorine-containing quaternary ammonium salt having the formula (I) and a metal-containing azo pigment.

Specific examples of the fluorine compound having the formula (I) include fluorine compounds having the following formulae (1) to (27), and all of them are white or pale yellow. Y is preferably iodine.

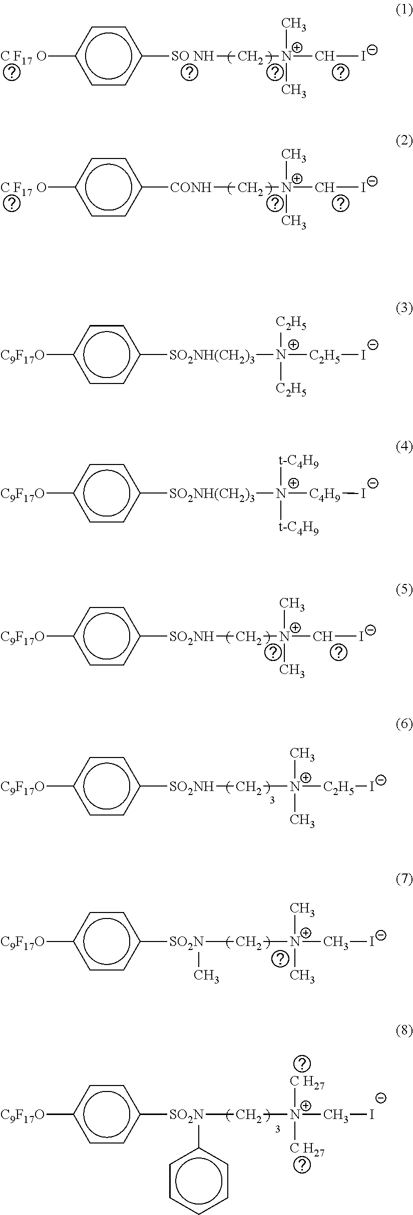

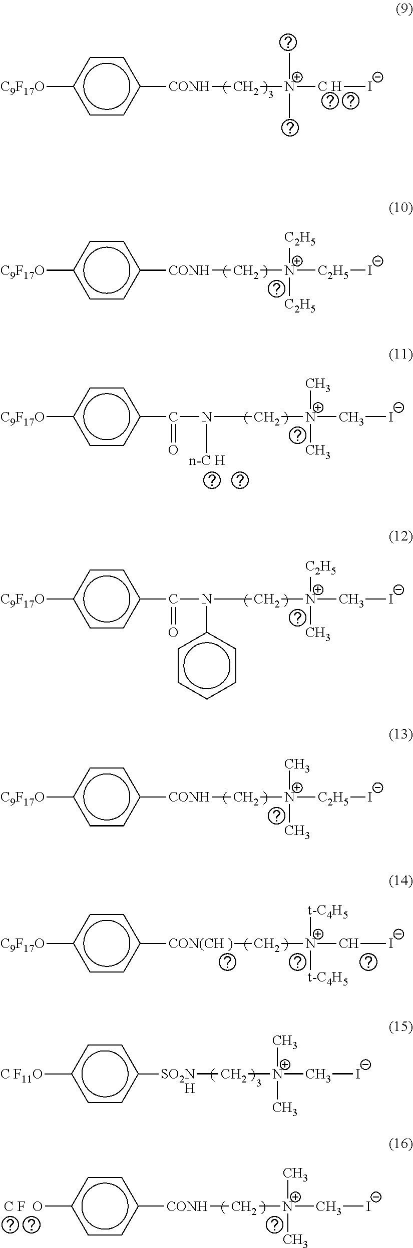

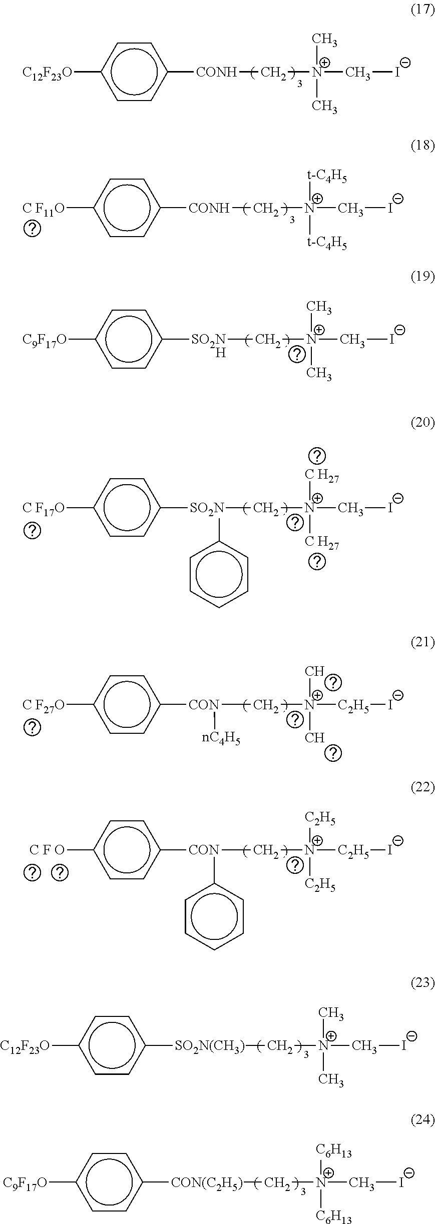

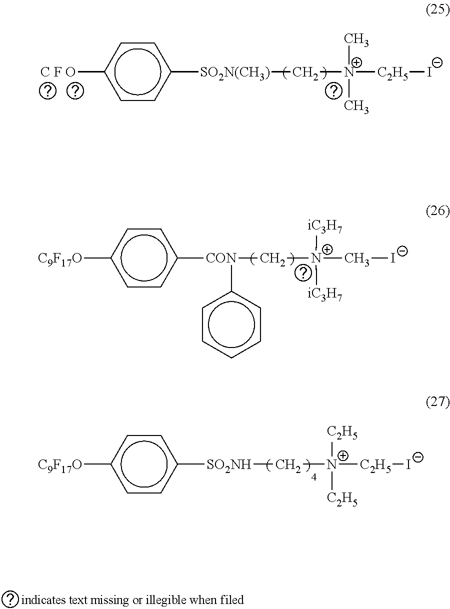

Among these, N,N,N-trimethyl-[3-(4-perfluorononenyloxybenzamide)propyl]ammonium iodide is preferably used in terms of chargeability. The effects of the present invention are not limited by purity, pH or pyrolytic temperature of the fluorine-compound. The toner preferably includes the fluorine-compound in an amount of from 0.01 to 5% by weight, and more preferably from 0.01 to 3% by weight. When less than 0.01% by weight, the fluorine compound does not fully exert its effect. When greater than 5% by weight, the toner is not sufficiently fixed.

A ratio of the number of fluorine atoms to that of carbon atoms (F/C) is preferably less than 0.010, and more preferably less than 0.005. The methanol wettability of the toner of the present invention depends on the surface condition thereof In order to decrease the wettability, a method of adsorbing a fluorine-containing surfactant to the surface thereof and a method introducing a fluoroalkyl group in the binder resin skeleton and dry-heating the fluoroalkyl group to be oriented thereto have some effects. However, the toner surface hydrophobized by fluorine impairs fixability, particularly low-temperature fixability, and therefore the less fluorine the better.

The resin is washed by a centrifugal separation method, a reduced pressure filtration method or a filter press method, but the methods are not particularly limited thereto. A resin cake is obtained in any methods. When the resin is not fully washed at a time, the cake may be dispersed again in an aqueous solvent and any of the methods is repeated. When the reduced pressure filtration method or the filter press method is used, the aqueous solvent may be penetrated through the cake to wash way a side material the resin holds in. The aqueous solvent is water or a mixed solvent including water and alcohol such as methanol and ethanol. Water is preferably used in consideration of cost and environmental load such as effluent treatment.

The washed resin holds in the aqueous medium much, and is dried to remove the aqueous medium to obtain only the resin. Dryers such as a spray drier, a vacuum freeze drier, a reduced pressure drier, a static shelf drier, a fluidized-bed drier, a rotary drier and a stirring drier can be used. The resin is preferably dried to have a moisture content less than 1%. The resin after dried has flocculation, and which is loosened by a jet mill, a Henschel Mixer, a super mixer, a coffee mill, Oster blender, a food processor, etc.

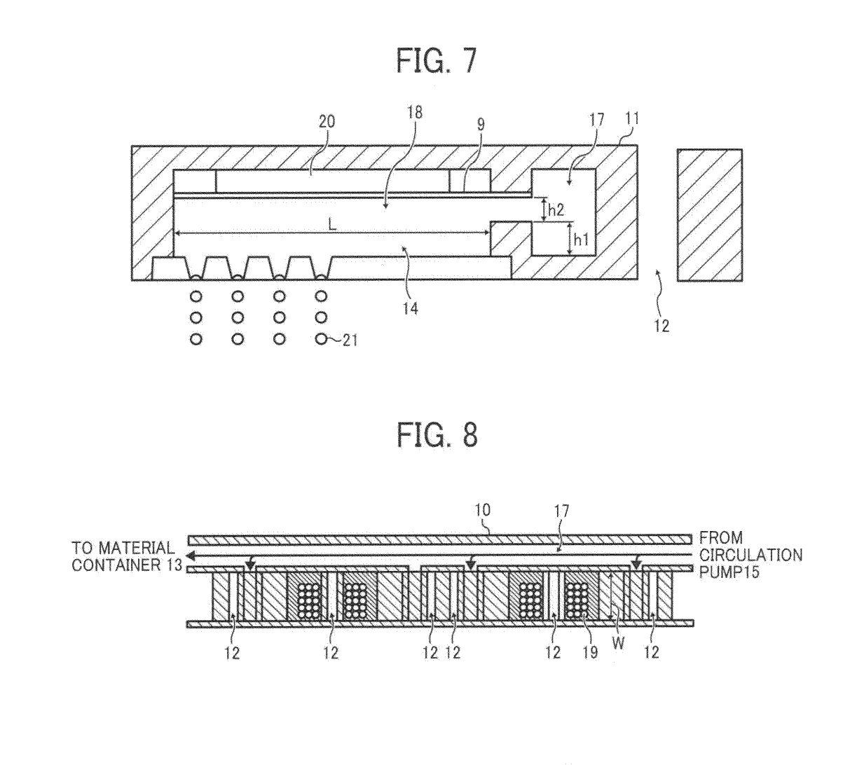

Embodiments of the method of not granulating a toner in an aqueous medium, e.g., discharging a toner composition liquid including at least a binder resin and a colorant from a through-hole to form a droplet are explained, referring to FIGS. 7 to 11. The toner preparation apparatus is divided into a droplet discharger and a droplet solidifier and collector.

The droplet discharger preferably projects a droplet having a narrow particle diameter distribution, but is not particularly limited and known droplet dischargers can be used. Specific examples of the droplet discharger include one-fluid nozzles, two-fluid nozzles, film oscillation discharge means, Rayleigh split discharge means, liquid oscillation discharge means, liquid-column resonant discharge means, etc. Japanese published unexamined application No. 2008-292976 discloses an embodiment of the film oscillation discharge means, Japanese Patent No, 4647506 discloses an embodiment of the Rayleigh split discharge means, and Japanese published unexamined application No. 2010-102195 discloses an embodiment of the liquid oscillation discharge means.

In order to ensure narrow article diameter distribution and productivity of a toner, a liquid-column resonant droplet discharger plural discharge holes are formed on is preferably used.

In the present invention, as mentioned above, after a droplet of the toner component liquid discharged from the droplet discharger is solidified, the solidified droplet is collected.

Methods of solidifying the discharged droplet depend on properties of the toner component liquid, but may be any methods if the toner component liquid can be solidified. When the toner component liquid includes an evaporable solvent and a toner component dissolved or dispersed therein, a discharged droplet of the toner component liquid is dried and the solvent is evaporated in a feed airflow. The solvent is dried by properly selecting a temperature, a steam pressure, etc. of a gas in which the droplet is discharged. Even when the solvent is not completely dried, the collected particulate may be further dried in another process after collected if the particulate maintains solidity. Besides, methods of solidifying the droplet by changing temperature or chemical reaction may be used.

The solidified particle is collected from the gas by a known powder collector such as cyclone collectors and back filters.

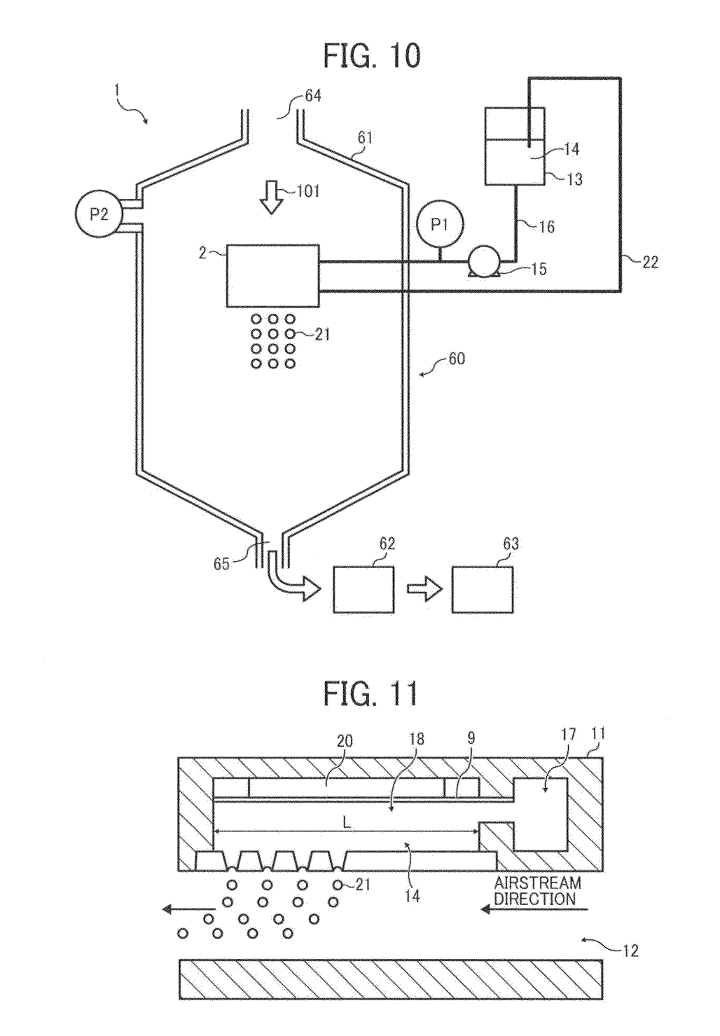

FIG. 10 is a schematic view illustrating an embodiment of a toner preparation apparatus in the present invention. The toner preparation apparatus is mainly formed of a droplet discharger 2, and a dry and collection unit 60.

The droplet discharger 2 is connected with a material container 13 containing the toner component liquid 14, and a circulation pump 15 feeding the toner component liquid 14 contained in the material container 13 to the droplet discharger 2 through a liquid feeding pipe 16 and returning the liquid to the material container 13 through a liquid returning pipe 22. The liquid feeding pipe 16 includes a pressure gauge P1, and the dry collection unit 60 includes a pressure gauge P2. A pressure to feed the liquid to the droplet discharger 2 and a pressure in the dry collection unit 60 are controlled, based on the measured results of the pressure gauges P1 and P2, respectively. When P1 is greater than P2, the toner component liquid 14 possibly exudes from the discharge hole 19. When P1 is smaller than P2, the liquid-column resonant droplet forming unit 10 possibly takes air in and stops discharging. Therefore, P1 and P2 are preferably equal to each other.

In a chamber 61, downdraft 101 is fed from a feed airflow inlet 64, and the droplet 21 discharged from the drop let discharger 2 is fed downward not only by gravity but also by the downdraft 101 and collected by the by a solidified particle collector 62.

When the discharged droplets contact each other before dried, they are combined to form a large particulate. Hereinafter, this is referred to as “cohesion”. In order to prepare a toner having a uniform particle diameter distribution, the discharged droplets needs to have a distance from each other. However, the discharged droplet has a constant initial velocity, but gradually loses velocity due to air resistance. Therefore, another droplet discharged after a droplet losing velocity occasionally catches up therewith, resulting in cohesion. The cohesion constantly occurs and the resultant particle diameter distribution seriously deteriorates when particles subjected to cohesion are collected. In the present invention, the downdraft 101 prevents droplets from losing velocity so as not to contact them with each other.

As FIG. 7, shows, the downdraft 101 runs downward, or may horizontally be running relative to the discharge direction of the droplet as FIG. 11 shows. However, in this case, the feed airflow is preferably formed such that trajectories of the droplets discharged from the discharge holes are not overlapped. The feed airflow may obliquely run, not only horizontally relative to the discharge direction of the droplet, and preferably has an angle such that the discharged droplets separate from each other.

A first airflow for preventing cohesion and a second airflow for feeding the solidified particle to the solidified particle collector may separately be formed. In this case, the first airflow preferably has a flow velocity equal to or not less than a running velocity of the droplet when discharged. When slower than the droplet when discharged, the first airflow possibly does not fully prevent the droplets from contacting with each other. The first airflow may have other additional properties to prevent the droplets from contacting with each other when necessary, and does not necessarily need the same properties as those of the second airflow. For example, the first airflow may include a chemical material accelerating solidification of the droplet or may be subjected to a physical action to accelerate solidification thereof.

In the present invention, the downdraft 101 may be a laminar flow, a swirl flow or a turbulent flow. Gases for the downdraft 101 are not particularly limited, and air or incombustible gases such as nitrogen may be used. The downdraft 101 has a temperature adjustable when necessary and preferably does not vary therein. A means of varying the airflow status of the downdraft 101 may be located in the chamber 61. The downdraft 101 may be used to prevent the droplet 21 from adhering to the inner surface of the chamber 61 besides preventing them from contacting with each other.

As FIG. 10 shows, when a toner collected by the solidified particle collector 62 includes much residual solvent, the drier 63 secondly dries the toner to decrease the residual solvent when necessary. Typically known driers such as fluidized-bed driers and vacuum driers can be used for the second drying. The residual organic solvent in a toner not only varies toner properties such as thermostable storageability, fixability and chargeability as time passes, the organic solvent evaporates when a toner image is fixed upon application of heat and possibly has adverse influences on various devices in an image forming apparatus. Therefore, it is desired that the toner is fully dried.

A ratio (Tsh2nd/Tsh1st) of a shoulder temperature of a melting heat peak of a second heating Tsh2nd to a shoulder temperature of a melting heat peak of a first heating Tsh1st when measured by the differential scanning calorimeter (DSC) is preferably from 0.90 to 1.10. The shoulder temperatures of the melting heat peaks of the toner (Tsh1st and Tsh2nd) are measured by the differential scanning calorimeter (DSC) such as TA-60WS and DSC-60 from Shimadzu Corp. First, 5.0 mg of the toner are placed in a sample container made of aluminum, the sample container is placed on a holder unit and the holder unit is set in an electric oven. Next, the holder unit is heated from 0 to 150° C. at a temperature increase rate of 10° C./min under a nitrogen atmosphere. Then, the holder unit is cooled from 150 to 0° C. at a temperature decrease rate of 10° C./min, and heated again to 150° C. at a temperature increase rate of 10° C./min to form a DCS curve. In the DCS curve, an endothermic peak temperature in the first heating is Tm1st and an endothermic peak temperature in the second heating is Tm2nd. When there are plural endothermic peaks, a peak having the maximum endothermic amount is selected. For each of Tm1st and Tm2nd, intersections between a base line at a lower temperature side and tangent of a slope thereof are Tsh1st and Tsh2nd, respectively.

The crystallization of the toner and the resin in the present invention is an area ratio between a main diffraction peak and hallo in a diffraction profile obtained by an X-ray diffraction measurement. An X-ray diffraction measurement method and a method of determining the crystallization are explained.

(1) X-Ray Diffraction Measurement Method

The diffraction profiles of the toner and the resin are measured by an X-ray diffraction apparatus equipped with a two-dimensional detector D8 DISCOVER with GADDS from Bruker Corp. under the following conditions.

Tube current: 40 mA

Tube voltage: 40 kV

Goniometer: 2θ axis: 20.0000°

Goniometer: Ω axis: 0.0000°

Goniometer: Φ axis: 0.0000°

Detector distance: 15 cm (wide-angle measurement)

Measurement range: 3.2≦2θ(°)≦37.2

Measurement time: 600 sec

A collimator having a pin hole of Φ 1 mm is used as an incident optical system. Two-dimensional original data obtained were integrated with an auxiliary software (at an x-axis of from 3.2 to)37.2° and converted to a diffraction intensity and one-dimensional data.

Mark Tube (Lindemann glass) having a diameter of 0.70 mm is used as a capillary. A sample is packed up to the top of the capillary tube. Tapping for 100 times is performed to pack the sample.

(2) Crystallization Measurement Method

Based on a chart obtained from the X-ray diffraction measurement, a method of determining the crystallization is explained.

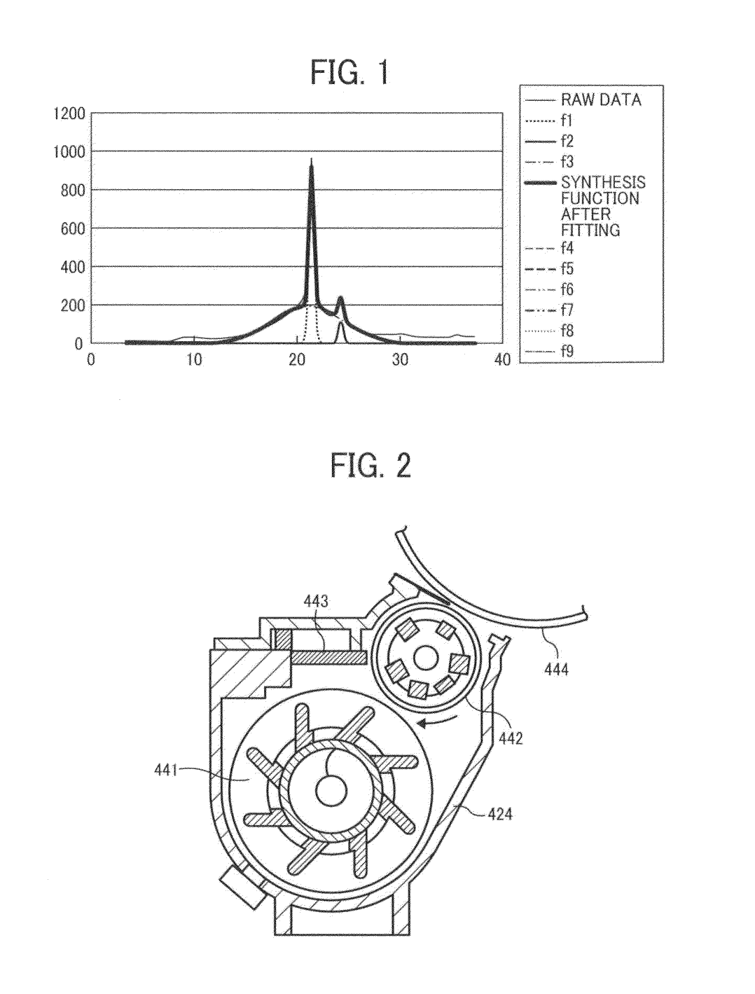

An example of the diffraction profile obtained by the X-ray diffraction measurement is shown in FIG. 1.

X-axis is 2θ, Y-axis is an X-ray diffraction intensity, and both of them are linear axes. Am X-ray diffraction pattern of the crystalline resin of the present invention has main peaks P1 and P2 at 2θ=21.3° and 2θ=24.2°, and hallo (h) is seen in a wide range including these two peaks. The main peaks are thought from the crystalline part and the hallo is thought from the amorphous part.

These two main peaks and the hallo are converted to Gauss functions as follows.

fₚ₁(2θ)=aₚ₁exp(−(2θ−bₚ₁)²/(2cₚ₁²))

fₚ₂(2θ)=aₚ₂exp(−(2θ−bₚ₂)²/(2cₚ₂²))

fₕ(2θ)=aₕexp(−(2θ−bₕ)²/(2cₕ²))

wherein fₚ₁(2θ), fₚ₂(2θ) and fₕ(2θ) are functions correspondent to the main peaks P1 and P2, and the hallo.

Relative to a total of these three functions, i.e.,

f(2θ)=fₚ₁(2θ)+fₚ₂(2θ)+fₕ(2θ)

fitting with the X-ray diffraction profile is performed by a least-square method.

Fitting by the least-square method is for nine aₚ₁, bₚ₁, cₚ₁, aₚ₂, bₚ₂, cₚ₂, aₕ, bₕ, and cₕ, and performed after making bₚ₁=21.3 and bₚ₁=24.2, bₚ₁=22.5 as initial values, and other variables properly entered to accord the two main peaks and the hallo to the X-ray diffraction profile to some extent. Fitting can be performed by using Excel 2003 solver from Microsoft Corp.

After fitting, fₚ₁(2θ), fₚ₂(2θ) and fₕ(2θ) are gauss integrated to determine peak areas Sp1, Sp2 and Sh, respectively. The crystallization is determined as follows:

Crystallization (%)=((Sp1+Sp2)/(Sp1+Sp2+Sh)×100

wherein Sp1=Sp2=aₚ₁|cₚ₁|π^{1/2}, Sp2=aₚ₂|cₚ₂|π^{1/2} and Sh=aₕ|cₕ|π^{1/2}, respectively,

Therefore,

Crystallization (%)=((aₚ₁cₚ₁+aₚ₂cₚ₂)/(aₚ₁cₚ₁+aₚ₂cₚ₂+aₕcₕ)×100.

The toner has a storage elastic modulus at 70° C. G′ (70) Pa larger than 5.0×10⁴ and less than 5.0×10⁵, and preferably larger than 1.0×10⁵ and less than 3.0×10⁵. In addition, the toner has a storage elastic modulus at 160° C. G′ (160) Pa larger than 1.0×10³ and less than 1.0×10⁴, and preferably larger than 2.0×10³ and less than 7.0×10³. This is because these storage elastic modulus are favorable for the toner to have fixability and hot offset resistance.

The storage elastic modulus is obtainable by controlling a ratio between the crystalline monomer and the amorphous monomer forming the binder resin or molecular weight of the resin. When a ratio of the crystalline monomer is increases, G′ (Ta+20) is small.

The developer of the present invention includes the toner and other components such as a carrier when necessary.

The developer may be a one-component developer or a two-component developer, and the two-component developer is preferably used to improve longevity thereof when used in high-speed printers in compliance with the recent information process speed. The one-component developer may be a magnetic toner or a non-magnetic toner.

The one-component developer has less variation of particle diameter, no filming over a developing roller, and no melting and adhering to a toner layer thickness regulator such as a blade even when fed and consumed, and has good and stable developability and image productivity even when stirred for long periods. Further, the two-component developer has less variation of particle diameter even when fed and consumed for long periods, and has good and stable developability even when stirred for long periods.

The carrier is not particularly limited, and can be selected in accordance with the purpose, however, preferably includes a core material and a resin layer coating the core material.

The core material is not particularly limited, and can be selected from known materials such as Mn—Sr materials and Mn—Mg materials having 50 to 90 emu/g; and highly magnetized materials such as iron powders having not less than 100 emu/g and magnetite having 75 to 120 emu/g for image density. In addition, light magnetized materials such as Cu—Zn materials having 30 to 80 emu/g are preferably used to decrease a stress to a photoreceptor having toner ears for high-quality images. These can be used alone or in combination.

The core material preferably has a volume-average particle diameter (D50) of from 10 to 200 μm, and more preferably from 40 to 100 μm. When less than 10 μm, a magnetization per particle is so low that the carrier scatters. When larger than 200 μm, a specific surface area lowers and the toner occasionally scatters, and a solid image of a full-color image occasionally has poor reproducibility.

The resin coating the core material is not particularly limited, and can be selected in accordance with the purpose. Specific examples of the resin include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, fluoroterpolymers of tetrafluoroethylene, vinylidenefluoride and other monomers including no fluorine atom, and silicone resins. These can be used alone or in combination. Among these, silicone resins are preferably used.

Specific examples of the silicone resin include, but are not limited to, any known silicone resins such as straight silicones formed only of organosiloxane bonds and silicones modified with a resin such as an alkyd resin, a polyester resin, an epoxy resin, an acrylic resin and a urethane resin.

Specific examples of marketed products of the straight silicones include, but are not limited to, KR271, KR255 and KR152 from Shin-Etsu Chemical Co., Ltd; and SR2400, SR2406 and SR2410 from Dow Corning Toray Silicone Co., Ltd. The straight silicone resins can be used alone, and a combination with other constituents crosslinking therewith or charge controlling constituents can also be used.

Specific examples of the modified silicones include, but are not limited to, KR206 (alkyd-modified), KR5208 (acrylic-modified), EX1001N (epoxy-modified) and KR305 (urethane-modified) from Shin-Etsu Chemical Co., Ltd; and SR2115 (epoxy-modified) and SR2110 (alkyd-modified) from Dow Corning Toray Silicone Co., Ltd.

The silicone resin can be used alone, and with crosslinkable components and charge controlling agents as well.

The resin layer may include an electroconductive powder when necessary, and specific examples thereof include metallic powders, carbon black, titanium oxide, tin oxide, zinc oxide, etc. The electroconductive powder preferably has an average particle diameter not greater than 1 μm. When greater than 1 μm, it is occasionally difficult to control electrical resistance.

The resin layer can be formed by preparing a coating liquid including a solvent and, e.g., the silicone resin; uniformly coating the liquid on the surface of the core material by a known coating method; and drying the liquid and burning the surface thereof. The coating method includes dip coating methods, spray coating methods, brush coating method, etc.

Specific examples of the solvent include, but are not limited to, toluene, xylene, methyl ethyl ketone, methyl isobutyl ketone, cellosolve butyl acetate, etc.

Specific examples of the burning methods include, but are not limited to, externally heating methods or internally heating methods using fixed electric ovens, fluidized electric ovens, rotary electric ovens, burner ovens, microwaves, etc.

The carrier preferably includes the resin layer in an amount of from 0.01 to 5.0% by weight. When less than 0.01% by weight, a uniform resin layer cannot be formed on the core material. When greater than 5.0% by weight, the resin layer becomes so thick that carrier particles granulate one another and uniform carrier particles cannot be formed.

The content of the carrier in a two-component developer is not particularly limited, and can be selected in accordance with the purpose. The developer preferably includes the carrier in an amount of from 90 to 98% by weight, and more preferably from 93 to 97% by weight.

The two-component developer preferably includes the toner in an amount of from 1 to 10.0 parts by weight per 100 parts by weight of the carrier.

The image forming apparatus of the present invention includes at least an electrostatic latent image bearer, an electrostatic latent image former, an image developer, a transferer and a fixer; more preferably a cleaner; and further includes other means such as a discharger, a recycler and a controller when necessary.

The image developer is a means of developing an electrostatic latent image with a toner to form a visual image, and the toner is the toner of the present invention.

The charger and an irradiator are occasionally combined to be called the electrostatic latent image former. The image developer includes a fixed magnetic field generator and a rotatable developer bearer bearing the toner of the present invention.

A material, shape, structure, size, etc. of the electrostatic latent image bearer are not particularly limited, and can be selected according to the purposes. The electrostatic latent image bearer has the shape of a drum, a sheet or an endless belt. The electrostatic latent image bearer may have a single-layered structure or a multilayered structure. The electrostatic latent image bearer may be formed of inorganic materials such as amorphous silicon, serene, CdS and ZnO or organic materials such as polysilane and phthalopolymethine.

The charger charges the surface of the electrostatic latent image bearer.

The charger is not particularly limited, provided it can uniformly charge the surface of the electrostatic latent image bearer when applied with a voltage. The charger is broadly classified into (1) a contact charger contacting the electrostatic latent image bearer to charge and (2) a non-contact charger not contacting the electrostatic latent image bearer to charge.

Specific examples of (1) the contact charger include an electroconductive or a semiconductive charging roller, a magnetic bush, a fur brush, a film, a rubber blades, etc. The charging roller generates much less ozone than a corona discharger, and the electrostatic latent image bearer can stably be used even when repeatedly used, and which effectively prevents deterioration of image quality.

Specific examples of (2) the non-contact charger include a non-contact charger and a needle electrode device using corona discharge; a solid discharge element; and an electroconductive or a semiconductive charging roller having a microscopic gap between the electrostatic latent image bearer and the roller.

The irradiator irradiates the charged surface of the electrostatic latent image bearer to form an electrostatic latent image.

The irradiator is not particularly limited, provided that the irradiator can irradiate the surface of the electrostatic latent image bearer with the imagewise light, and specific examples thereof include reprographic optical irradiators, rod lens array irradiators, laser optical irradiators and a liquid crystal shutter optical irradiators. In the present invention, a backside irradiation method irradiating the surface of the electrostatic latent image bearer through the backside thereof may be used.

The image developer is not particularly limited, and can be selected from known image developers, provided that the image developer can develop with the toner of the present invention. For example, an image developer containing the developer of the present invention and being capable of feeding the toner to the electrostatic latent image in contact or not in contact therewith is preferably used.

The image developer is a means of developing an electrostatic latent image with the toner to form a visual image, and the toner is the toner of the present invention.

The image developer may use dry or wet developing method, and may be single-color image developer or multi-color image developer.

The image developer preferably includes a stirrer stirring the developer of the present invention to be frictionally charged, a fixed magnetic field generator, and a rotatable developer bearer bearing a developer including the toner on the surface.

In the image developer, the toner and the carrier are mixed and stirred, and the toner is charged and held on the surface of the rotatable magnet roller in the shape of an ear to form a magnetic brush. Since the magnet roller is located close to the electrostatic latent image bearer, a part of the toner is electrically attracted to the surface thereof Consequently, the electrostatic latent image is developed with the toner to form a visual image thereon.

FIG. 2 is a schematic view illustrating a two-component image developer. In the two-component image developer, a two-component developer is stirred and fed by a screw 441 to a developing sleeve 442 as a developer bearer. The two-component developer fed to the developing sleeve 442 is regulated by a doctor blade 443 as a layer thickness regulation member, and an amount of the developer fed is controlled by a doctor gap between the doctor blade 443 and the developing sleeve 442. When the doctor gap is too small, the amount of the developer is too small to produce images having sufficient image density. When too large, the developer is excessively fed, resulting in carrier adherence on the electrostatic latent image bearer. The developing sleeve 442 includes a magnet as a magnetic field generator forming a magnetic field to form ears of the developer on the circumferential surface. Along a magnetic line in normal direction from the magnet, ears of the developer are formed on the developing sleeve 442 to form a magnetic brush.

The developing sleeve 442 and the electrostatic latent image bearer are located close to each other across a specific distance (developing gap), and a developing area is formed at a part where they face each other. The developing sleeve 442 is formed of a cylindrical non-magnetic materials such as aluminum, brass, stainless and electroconductive resin, and is rotatable by an unillustrated rotor. The magnetic brush is transferred to the developing area by rotation of the developing sleeve 442. The developing sleeve 442 is applied with a developing bias by an unillustrated electrical source for development, and a toner on the magnetic brush is separated by a developing electric field formed between the developing sleeve 442 and the electrostatic latent image bearer and transferred onto an electrostatic latent thereon. The developing bias may be overlapped with an AC bias.

The developing gap preferably has a size 5 to 30 times as large as a particle diameter of the developer, and when the developer has a particle diameter of 50 μm, the developing gap preferably has a size of from 0.25 to 1.5 mm. When larger than this, images having desirable image density are occasionally difficult to produce.

The doctor gap preferably has a size equivalent to or a little larger than that of the developing gap. When the electrostatic latent image bearer is a drum-shaped photoreceptor, a diameter and a linear speed of the drum and those of the developing sleeve 442 depend on copy speed and a size of the apparatus. A ratio of the linear speed of the sleeve to that of the drum is preferably not less than 1.1 to produce images having required image density. A toner adherence amount may be detected by a sensor from an optical reflectance after developed to control process conditions.

The transferer is a means of transferring the visual image onto a recording medium.

The transferer is broadly classified into a direct transferer directly transferring a visual image on the electrostatic latent image bearer onto a recording medium and an indirect transferer first transferring a visual image onto an intermediate transferer and secondly transferring the visual image onto a recording medium therefrom. Any of the transferers are not particularly limited, and can be selected from known transferers.

The fixer is a means of fixing a visual image on a recording medium.

The fixer is not particularly limited, and can be selected according the purposes. A fixer having a fixing member and a heat source heating the fixing member is preferably used. The fixing member is not particularly limited, provided it can form a nip. Specific examples thereof include a combination of an endless belt and a roller, and a roller and a roller. The combination of an endless belt and a roller, and a heating method from the surface of the fixing member by induction heating are preferably used in terms of shortening warm-up and energy saving.

The fixer is broadly classified into (1) an inner heating fixer including at least a roller or a belt, heating from a surface not contacting a toner, and heating and pressing an image transferred onto a recording medium to be fixed thereon; and (2) an outer heating fixer including at least a roller or a belt, heating from a surface contacting a toner, and heating and pressing an image transferred onto a recording medium to be fixed thereon. They can be combined.

Specific examples of (1) the inner heating fixer include fixers having a fixing member including a heater. The heater includes heat sources such as a heater and a halogen lamp.

Specific examples of (2) the outer heating fixer include fixers having at least one fixing member at least a part of the surface of which is heated by a heater. The heater is not particularly limited, and can be selected according to the purposes. Specific examples thereof include an electromagnetic induction heater. The electromagnetic induction heater is not particularly limited, and can be selected according to the purposes. The electromagnetic induction heater preferably has a means of generating a magnetic field and a means of heating by electromagnetic induction. Specific example of the means of heating by electromagnetic induction include a means formed of an induction coil located close to the fixing member such as a heat roller, a shielding layer including the induction coil, and an insulative layer located opposite to the shielding layer. The heat roller is preferably a magnetic heat pipe. The induction coil is preferably located so as to cover at least a semi-cylindrical part if the heat roller at an opposite side of a contact point between the heat roller and the fixing member such as a pressure roller and an endless belt.

The process cartridge of the present invention includes at least an electrostatic latent image bearer and an image developer, and further includes other means such as a charger, an irradiator, a transferer, a cleaner and a discharger when necessary.

The image developer is a means of developing an electrostatic latent image borne on the electrostatic latent image bearer with a toner to form a visual image, and the toner is the toner of the present invention.

The image developer includes at least a toner container containing the toner of the present invention and a toner bearer bearing and feeding the toner contained in the toner container. The mage developer may further include a regulation member regulating a thickness of the toner borne by the toner bearer. The image developer preferably includes a two-component developer and a developer bearer bearing and feeding the two-component developer contained in the developer container. Specifically, any of the image developers mentioned above can preferably be used.

In addition, the above-mentioned charger, irradiator, transferer, cleaner and discharger can selectively be used.

The process cartridge of the present invention is detachably equipped with various electrophotographic image forming apparatuses such as facsimiles and printers, and preferably equipped with the electrophotographic image forming apparatus of the present invention.

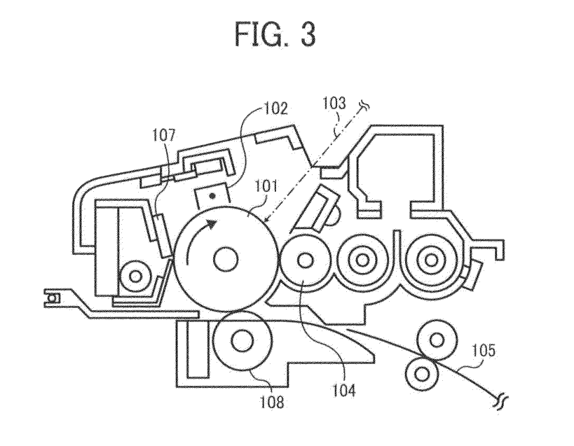

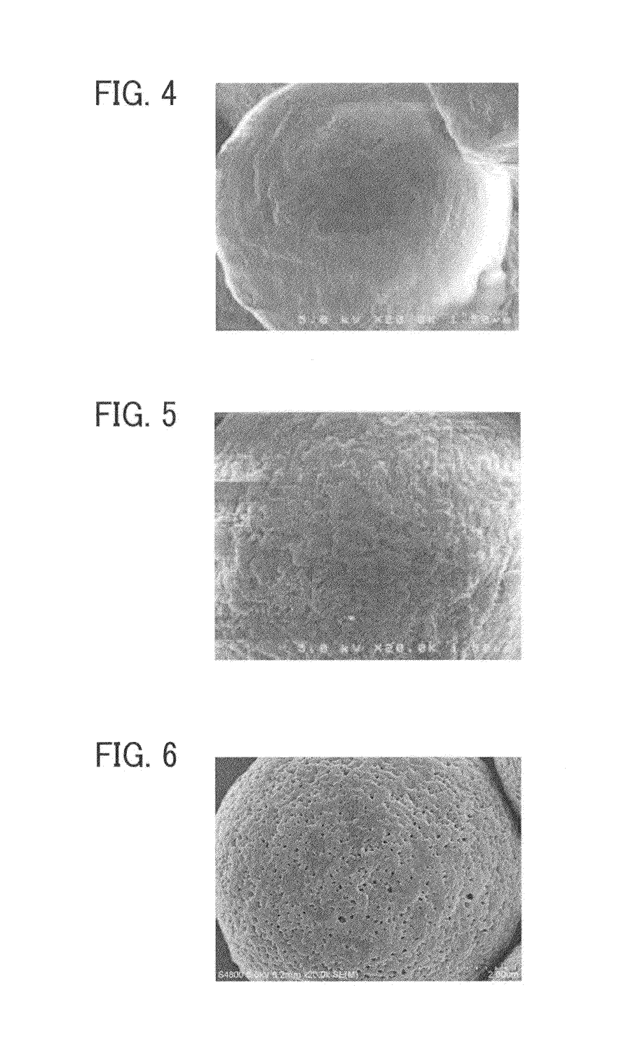

The process cartridge includes, as FIG. 3 shows, an electrostatic latent image bearer 101, a charger 102, an image developer 104, a transferer 108, a cleaner 107 and other means when necessary. In FIG. 3, numeral 103 represents an irradiation and 105 represents a recording medium.

Next, an image forming process by the process cartridge in FIG. 3 is explained. The electrostatic latent image bearer 101 is charged by the charger 102 and irradiated (103) by an unillustrated irradiator while rotating in an arrow direction to form an electrostatic latent image on the surface thereof. The electrostatic latent image is developed by the image developer 104 with a toner to form a toner image. The toner image is transferred by the transferer 108 onto the recording medium 105, and printed out. Then, the surface of the electrostatic latent image bearer is cleaned by the cleaner 107 after the toner image is transferred, further discharged by an unillustrated discharger, and the above-mentioned operation is repeated.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

<Crystalline Resin 1>

In a reaction vessel including a cooling pipe, a stirrer and a nitrogen inlet tube, 241 parts of sebacic acid, 31 parts of adipic acid, 164 parts of 1,4-butanediol and 0.75 parts of titaniumdihydroxybis(triethanolaminate) as a condensation catalyst were reacted for 8 hrs under a nitrogen stream at 180° C. while produced water is removed. Next, the reactant was reacted for 4 hrs while gradually heated to have a temperature of 225° C. under a nitrogen stream and produced water and 1,4-butanediol were removed. The reactant was further reacted under reduced pressure by 5 to 20 mm Hg until the reactant had a weight-average molecular weight about 18,000 to prepare a [crystalline resin 1] (crystalline polyester resin) having a melting point of 58° C.

<Crystalline Resin 2>

In a reaction vessel including a cooling pipe, a stirrer and a nitrogen inlet tube, 283 parts of sebacic acid, 215 parts of 1,6-hexanediol and 1 part of titaniumdihydroxybis(triethanolaminate) as a condensation catalyst were reacted for 8 hrs under a nitrogen stream at 180° C. while produced water is removed. Next, the reactant was reacted for 4 hrs while gradually heated to have a temperature of 220° C. under a nitrogen stream and produced water and 1,6-hexanediol were removed. The reactant was further reacted under reduced pressure by 5 to 20 mm Hg until the reactant had a weight-average molecular weight about 17,000 to prepare a [crystalline resin 2] (crystalline polyester resin) having a melting point of 63° C.

<Crystalline Resin 3>

In a reaction vessel including a cooling pipe, a stirrer and a nitrogen inlet tube, 322 parts of dodecanedionic acid, 215 parts of 1,6-hexanediol and 1 part of titaniumdihydroxybis(triethanolaminate) as a condensation catalyst were reacted for 8 hrs under a nitrogen stream at 180° C. while produced water is removed. Next, the reactant was reacted for 4 hrs while gradually heated to have a temperature of 220° C. under a nitrogen stream and produced water and 1,6-hexanediol were removed. The reactant was further reacted under reduced pressure by 5 to 20 mm Hg until the reactant had a weight-average molecular weight about 6,000.

Two sixty-nine (269) parts of the resultant crystalline resin were placed in reaction vessel including a cooling pipe, a stirrer and a nitrogen inlet tube, and 280 parts of ethylacetate an 85 parts of tolylenediisocyanate (TDI) were added thereto an reacted for 5 hrs at 80° C. under a nitrogen stream. Next, ethylacetate was removed under reduced pressure to prepare a [crystalline resin 3] (crystalline polyurethane resin) having a weight-average molecular weight about 18,000 and a melting point of 68° C.

<Crystalline Resin 4>

In a reaction vessel including a cooling pipe, a stirrer and a nitrogen inlet tube, 283 parts of sebacic acid, 215 parts of 1,6-hexanediol and 1 part of titaniumdihydroxybis(triethanolaminate) as a condensation catalyst were reacted for 8 hrs under a nitrogen stream at 180° C. while produced water is removed. Next, the reactant was reacted for 4 hrs while gradually heated to have a temperature of 220° C. under a nitrogen stream and produced water and 1,6-hexanediol were removed. The reactant was further reacted under reduced pressure by 5 to 20 mm Hg until the reactant had a weight-average molecular weight about 6,000.

Two forty-nine (249) parts of the resultant crystalline resin were placed in reaction vessel including a cooling pipe, a stirrer and a nitrogen inlet tube, and 250 parts of ethylacetate an 82 parts of hexamethylenediisocyanate (HDI) were added thereto an reacted for 5 hrs at 80° C. under a nitrogen stream. Next, ethylacetate was removed under reduced pressure to prepare a [crystalline resin 4] (crystalline polyurethane resin) having a weight-average molecular weight about 20,000 and a melting point of 65° C.

<Amorphous Resin 1>

Two twenty-nine (229) parts of an adduct of bisphenol A with 2 moles of ethyleneoxide, 529 parts of an adduct of bisphenol A with 2 moles of propyleneoxide, 208 parts terephthalic acid, 46 parts of adipic acid and 2 parts of dibutyltinoxide were reacted in a reaction vessel including a cooling pipe, a stirrer and a nitrogen inlet pipe for 8 hrs at a normal pressure and 230° C. Further, after reactant was depressurized by 10 to 15 mm Hg and reacted for 5 hrs, 44 parts of trimellitic acid anhydride were added thereto and the reactant was reacted for 2 hrs at a normal pressure and 180° C. to prepare an [amorphous resin 1]. The [amorphous resin 1] had a number-average molecular weight (Mn) of 2,500, a weight-average molecular weight (Mw) of 6,700, a glass transition temperature (Tg) of 43° C. and an acid value of 25 mg KOH/g.

<Crystalline Resin Prepolymer>

In a reaction vessel including a cooling pipe, a stirrer and a nitrogen inlet tube, 247 parts of hexamethylenediisocyanate (HDI) and 247 parts of ethylacetate were placed. Further, a resin solution including 249 parts of the [crystalline resin 4] and 249 parts of ethylacetate was added to the mixture, and reacted at 80° C. for 5 hrs under a nitrogen stream to prepare an ethylacetate solution including a crystalline resin precursor having an isocyanate group at the end in an mount of 50% by weight [crystalline prepolymer 1] (modified polyester resin).

<Amorphous Resin Prepolymer>

Six eighty-two (682) parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reaction vessel including a cooling pipe, a stirrer and a nitrogen inlet pipe for 8 hrs at a normal pressure and 230° C. Further, after the mixture was depressurized to 10 to 15 mm Hg and reacted for 5 hrs to prepare an [intermediate polyester 1]. The [intermediate polyester 1] had a number-average molecular weight of 2,100, a weight-average molecular weight of 9,500, a Tg of 55° C. and an acid value of 0.5 mg KOH/g and a hydroxyl value of 49 mg KOH/g.

Next, 411 parts of the [intermediate polyester 1-1], 89 parts of isophoronediisocyanate and 500 parts of ethyl acetate were reacted in a reaction vessel including a cooling pipe, a stirrer and a nitrogen inlet pipe for 5 hrs at 100° C. to prepare an [amorphous prepolymer 1]. The [amorphous prepolymer 1] included a free isocyanate in an amount of 1.53% by weight.

<Colorant Dispersion>

Twenty (20) parts of copper phthalocyanine, 4 parts of a colorant dispersant (SOLSPERSE 28000 from Avecia Inc.) and 76 parts of ethylacetate were placed in a beaker, and mixed and uniformly dispersed. Then, the copper phthalocyanine was finely dispersed by a beads mill to prepare a [colorant dispersion 1]. The [colorant dispersion 1] was measured by LA-920 from HORIBA, Ltd. to find a volume-average particle diameter thereof was 0.3 μm.

<Wax Dispersion>

In a reaction vessel including a cooling pipe, a thermometer and a stirrer, 15 parts of a paraffin wax HNP-9 (having a melting point of 75° C. from Nippon Seiro Co., Ltd.) and 85 parts of ethylacetate were placed. The mixture was heated to have a temperature of 78° C. so that the wax was fully dissolved and cooled to have a temperature of 30° C. for 1 hr while stirred. The mixture was further wet-pulverized by a beads mill (Ultra Visco Mill from IMECS CO., LTD.) for 6 passes under the following conditions:

liquid feeding speed of 1.0 kg/hr; peripheral disc speed of 10 m/sec; and filling zirconia beads having diameter of 0.5 mm for 80% by volume.

Finally, ethylacetate was added thereto to have a solid concentration of 15%. Thus, a [wax dispersion 1] was prepared.

### Example 1

In a reaction vessel including a thermometer and a stirrer, 100 parts of the [crystalline resin 1] and 100 parts of ethylacetate were placed, and the mixture was heated to have a temperature of 50° C. and uniformly stirred to prepare a [resin solution 1].

In a beaker, 45 parts of the [resin solution 1], 15 parts of the [crystalline prepolymer 1], 14 part of the [wax dispersion 1] and 10 parts of the [colorant dispersion 1] were placed, and the mixture was stirred by a T. K. HOMO MIXER at 50° C. and 8,000 rpm to be uniformly dissolved and dispersed to prepare a [toner material liquid 1].

In a beaker, 99 parts of ion-exchanged water, 6 parts an aqueous dispersion including an organic particulate resin (a copolymer of styrene-methacrylate-butylacrylate-sodium salt of a sulfate ester with an adduct of ethylene oxide methacrylate for stabilizing dispersion) in an amount of 25% by weight, 1 part of carboxymethylcellulose sodium, and 10 parts sodium dodecyldiphenyletherdisulfonate having a concentration of 48.5% (ELEMINOL MON-7 from Sanyo Chemical Industries, Ltd.) were uniformly dissolved.

Next, 75 parts of the [toner material liquid 1] were placed in the solution while stirred at 10,000 rpm and 50° C., and the solution was stirred for 2 min.

Next, the mixture was transferred into a flask including a stirring bar and a thermometer, and ethylacetate was removed to have a concentration of 0.5% at 55° C. to prepare an [aqueous resin particle dispersion 1].

Next, as a pre-washing process, the [aqueous resin particle dispersion 1] was cooled to have room temperature and filtered. Three hundred (300) parts of ion-exchanged water were added to the resultant filtered cake and mixed by a T. K. HOMO MIXER at 12,000 rpm for 10 min, and filtered. This operation was performed twice.

Next, as an alkalization process, 300 parts of ion-exchanged water were added to the resultant filtered cake and mixed by a T. K. HOMO MIXER at 12,000 rpm for 30 min. An aqueous solution including sodium hydrate in an amount of 10% by weight was added thereto to have a pH of 11.0. Then, the filtered cake was stirred for 10 hrs while heated at 45° C. and cooled to have room temperature and filtered under reduced pressure.

Further, as an after-washing process, 300 parts of ion-exchanged water were added to the resultant filtered cake and mixed by a T. K. HOMO MIXER at 12,000 rpm for 10 min, and filtered. This operation was performed three times. Three hundred (300) parts of hydrochloric acid including a solid content of 1% by weight were added to the resultant filtered cake and mixed by a T. K. HOMO MIXER at 12,000 rpm for 10 min, and filtered. Finally, 300 parts of ion-exchanged water were added to the resultant filtered cake and mixed by a T. K. HOMO MIXER at 12,000 rpm for 10 min, and filtered. This operation was performed twice to prepare a filtered cake.

The resultant cake was pulverized and dried at 40° C. for 22 hrs to prepare a [resin particle 1] having a volume-average particle diameter of 5.6 μum

One hundred (100) parts of the [resin particle 1] and 1.0 part of hydrophobic silica (H2000 from Clariant (Japan) K.K.) as an external additive were mixed by HENSCHEL MIXER from Mitsui Mining Co., Ltd. at a peripheral speed of 30 m/sec for 30 sec, and paused for 1 min, which was repeated for 5 times. Then, the particles were sieved by a mesh having an opening of 35 μm to prepare a [toner 1].

### Example 2

The procedure for preparation of the [toner 1] in Example 1 was repeated to prepare a [resin particle 2] and a [toner 2] except for having changed a pH of the alkalization process from 11.0 to 12.0.

### Example 3

The procedure for preparation of the [toner 1] in Example 1 was repeated to prepare a [resin particle 3] and a [toner 3] except for having changed a pH of the alkalization process from 11.0 to 10.0.

### Example 4

The procedure for preparation of the [toner 1] in Example 1 was repeated to prepare a [resin particle 4] and a [toner 4] except for having changed the temperature of the alkalization process from 45 to 55° C.

### Example 5

The procedure for preparation of the [toner 1] in Example 1 was repeated to prepare a [resin particle 5] and a [toner 5] except for having replaced the [crystalline resin 1] with the [crystalline resin 2].

### Example 6

Forty (40) g of the [crystalline resin 1] were added to 360 g of ion-exchanged water, and heated to have a temperature of 90° C. and a pH of 7.5 with an aqueous solution of sodium hydrate having a concentration of 4%. The mixture was stirred by ULTRA TURRAX T50 from IKA at 8.000 rpm while 0.8 g of an aqueous solution of dodecylbenzenesulfonate having a concentration of 10% was added thereto to prepare a [crystalline resin latex 1] having a central diameter of 320 nm. The latex had a solid content concentration of 11%.

One point one (1.1) g of an aqueous solution of dodecylbenzenesulfonate having a concentration of 10% was added to 360 g of ion-exchanged water, and an aqueous solution of sodium hydrate having a concentration of 4% was further added thereto to prepare an aqueous phase having a pH of 9.0. The aqueous phase was heated to have a temperature of 55° C. Next, 80 g of the [crystalline prepolymer 1] was heated to have a temperature of 55° C. to be fluid and placed in the aqueous phase. The mixture was stirred by ULTRA TURRAX T50 from IKA at 8.000 rpm for 10 min and ethylacetate was removed to have a concentration of 0.5% to prepare a [crystalline resin latex 2] having a central diameter of 350 nm. The latex had a solid content concentration of 10%.

The following compositions were mixed and dissolved, and dispersed by a homogenizer (IKA ULTRA TURRAX) and an ultrasonic irradiation to prepare a [cyan pigment dispersion B-1] having a central diameter of 150 nm.

| | |
|---|---|
| Cyan pigment C.I. Pigment Blue 15:3 | 50 g |
| (Copper phthalocyanine from Dainippon Ink And Chemicals, Inc.) | |
| Anionic surfactant Neogen SC | 5 g |
| Ion-exchanged water | 200 g |

The following compositions were mixed and heated to have a temperature of 97° C., and dispersed by ULTRA TURRAX T50 from IKA. Then, the mixture was dispersed by a golin homogenizer from MEIWAFOSIS CO., LTD. under the conditions of 105° C. and 550 kg/cm² for 20 times to prepare a [release agent dispersion C-1] having a central diameter of 190 nm.

| Paraffin wax (HNP-9 from Nippon Seiro Co.) | 100 g |
|---|---|
| Anionic surfactant Neogen SC | 5 g |
| Ion-exchanged water | 300 g |
| Crystalline resin latex 1 | 260 |
| Crystalline resin latex 2 | 120 |
| Cyan pigment dispersion B-1 | 10 |
| Release agent dispersion C-1 | 8 |
| Polyaluminum chloride | 0.15 |
| Ion-exchanged water | 400 |

The above-mentioned compositions were fully mixed and dispersed by a homogenizer ULTRA TURRAX T50 from IKA in a round stainless flask. The flask was heated to have a temperature of 48° C. in a heating oil bath while stirred to agglutinate particles. When the particle diameter was 5.7 μm, the mixture was adjusted to have a pH of 6.0 with an aqueous solution of sodium hydrate of 0.5 mo/l and heated to have a temperature of 70° C. while stirred. The mixture decreased pH to 5.6 while heated to have a temperature of 70° C., but which was maintained. When the particles have a circularity of 0.972, the mixture was cooled.

Next, as a pre-washing process, 300 parts of ion-exchanged water were added to the resultant filtered cake and mixed by a T. K. HOMO MIXER at 12,000 rpm for 10 min, and filtered. This operation was performed twice.

Next, as an alkalization process, 300 parts of ion-exchanged water were added to the resultant filtered cake and mixed by a T. K. HOMO MIXER at 12,000 rpm for 30 min. An aqueous solution including sodium hydrate in an amount of 10% by weight was added thereto to have a pH of 11.0. Then, the filtered cake was stirred for 10 hrs while heated at 45° C. and cooled to have room temperature and filtered under reduced pressure.

Further, as an after-washing process, 300 parts of ion-exchanged water were added to the resultant filtered cake and mixed by a T. K. HOMO MIXER at 12,000 rpm for 10 min, and filtered. This operation was performed three times. Three hundred (300) parts of hydrochloric acid including a solid content of 1% by weight were added to the resultant filtered cake and mixed by a T. K. HOMO MIXER at 12,000 rpm for 10 min, and filtered. Finally, 300 parts of ion-exchanged water were added to the resultant filtered cake and mixed by a T. K. HOMO MIXER at 12,000 rpm for 10 min, and filtered. This operation was performed twice to prepare a filtered cake.

The resultant cake was pulverized and dried at 40° C. for 22 hrs to prepare a [resin particle 6] having a volume-average particle diameter of 5.6 μm.

One hundred (100) parts of the [resin particle 6] and 1.0 part of hydrophobic silica (H2000 from Clariant (Japan) K.K.) as an external additive were mixed by HENSCHEL MIXER from Mitsui Mining Co., Ltd. at a peripheral speed of 30 m/sec for 30 sec, and paused for 1 min, which was repeated for 5 times. Then, the particles were sieved by a mesh having an opening of 35 μm to prepare a [toner 6].

### Example 7

The procedure for preparation of the [toner 1] in Example 1 was repeated to prepare a [resin particle 7] and a [toner 7] except for having changed a pH of the alkalization process from 11.0 to 12.0 and the time thereof from 10 to 2 hrs.

### Example 8

The procedure for preparation of the [toner 1] in Example 1 was repeated to prepare a [resin particle 8] and a [toner 8] except for having changed a pH of the alkalization process from 11.0 to 12.0 and the temperature thereof from 45 to 40° C.

### Example 9

After the alkalization process in Example 1, as an after-washing process, 300 parts of ion-exchanged water were added to the resultant filtered cake and mixed by a T. K. HOMO MIXER at 12,000 rpm for 10 min, and filtered. This operation was performed three times. Three hundred (300) parts of hydrochloric acid including a solid content of 1% by weight were added to the resultant filtered cake and mixed by a T. K. HOMO MIXER at 12,000 rpm for 10 min, and filtered. Finally, after 300 parts of ion-exchanged water were added to the resultant filtered cake and mixed by a T. K. HOMO MIXER at 12,000 rpm for 10 min, an aqueous solution including N,N,N-trimethyl-[3-(4-perfluorononeyloxybenzeamide)propyl]ammonium iodide, which is a compound having the formula (1) (FUTARGENT 310 from Neos) in an amount of 1% by weight was gradually added thereto while stirred for 30 min so as to be 0.05% by weight based on total weight of the final particle resin, and filtered. Three hundred (300) parts of ion-exchanged water were added to the resultant filtered cake and mixed by a T. K. HOMO MIXER at 12,000 rpm for 10 min, and filtered once.

The resultant cake was pulverized and dried at 40° C. for 22 hrs to prepare a [resin particle 9] having a volume-average particle diameter of 5.6 μm.

One hundred (100) parts of the [resin particle 9] and 1.0 part of hydrophobic silica (H2000 from Clariant (Japan) K.K.) as an external additive were mixed by HENSCHEL MIXER from Mitsui Mining Co., Ltd. at a peripheral speed of 30 m/sec for 30 sec, and paused for 1 min, which was repeated for 5 times. Then, the particles were sieved by a mesh having an opening of 35 μm to prepare a [toner 9].

### Example 10

After preparation of the [aqueous resin particle dispersion 1] in Example 1, as an alkalization process, 300 parts of ion-exchanged water were added to the resultant filtered cake and mixed by a T. K. HOMO MIXER at 12,000 rpm for 30 min. An aqueous solution including sodium hydrate in an amount of 10% by weight was added thereto to have a pH of 11.0. Then, the filtered cake was stirred for 10 hrs while heated at 45° C. and cooled to have room temperature and filtered under reduced pressure.

Further, as an after-washing process, 300 parts of ion-exchanged water were added to the resultant filtered cake and mixed by a T. K. HOMO MIXER at 12,000 rpm for 10 min, and filtered. This operation was performed three times. Three hundred (300) parts of hydrochloric acid including a solid content of 1% by weight were added to the resultant filtered cake and mixed by a T. K. HOMO MIXER at 12,000 rpm for 10 min, and filtered. Finally, 300 parts of ion-exchanged water were added to the resultant filtered cake and mixed by a T. K. HOMO MIXER at 12,000 rpm for 10 min, and filtered. This operation was performed twice to prepare a filtered cake.

The resultant cake was pulverized and dried at 40° C. for 22 hrs to prepare a [resin particle 10] having a volume-average particle diameter of 5.6 μm.

One hundred (100) parts of the [resin particle 10] and 1.0 part of hydrophobic silica (H2000 from Clariant (Japan) K.K.) as an external additive were mixed by HENSCHEL MIXER from Mitsui Mining Co., Ltd. at a peripheral speed of 30 m/sec for 30 sec, and paused for 1 min, which was repeated for 5 times. Then, the particles were sieved by a mesh having an opening of 35 μm to prepare a [toner 10].

### Comparative Example 1

The procedure for preparation of the [toner 1] in Example 1 was repeated to prepare a [resin particle 101] and a [toner 101] except for not having performed the alkalization process.

### Comparative Example 2

The procedure for preparation of the [toner 1] in Example 1 was repeated to prepare a [resin particle 102] and a [toner 102] except for having changed the temperature of the alkalization process from 45 to 20° C.

### Comparative Example 3

The procedure for preparation of the [toner 1] in Example 1 was repeated to prepare a [resin particle 103] and a [toner 103] except for not having added the aqueous solution including sodium hydrate to adjust a pH and having changed the temperature of the alkalization process from 45 to 50° C.

### Comparative Example 4

The procedure for preparation of the [toner 1] in Example 1 was repeated to prepare a [resin particle 104] and a [toner 104] except for having replaced the [crystalline resin 1] with the [amorphous resin 1] and the [crystalline prepolymer 1] with the [amorphous prepolymer 1] and changed the temperature of the alkalization process from 45 to 50° C.

### Comparative Example 5

Forty (40) g of the [amorphous resin 1] were added to 360 g of ion-exchanged water, and heated to have a temperature of 90° C. and a pH of 7.5 with an aqueous solution of sodium hydrate having a concentration of 4%. The mixture was stirred by ULTRA TURRAX T50 from IKA at 8.000 rpm while 0.8 g of an aqueous solution of dodecylbenzenesulfonate having a concentration of 10% was added thereto to prepare an [amorphous resin latex 1] having a central diameter of 290 nm. The latex had a solid content concentration of 11%.

One point one (1.1) g of an aqueous solution of dodecylbenzenesulfonate having a concentration of 10% was added to 360 g of ion-exchanged water, and an aqueous solution of sodium hydrate having a concentration of 4% was further added thereto to prepare an aqueous phase having a pH of 9.0. Next, 80 g of the [amorphous prepolymer 1] was heated to have a temperature of 55° C. to be fluid and placed in the aqueous phase. The mixture was stirred by ULTRA TURRAX T50 from IKA at 8.000 rpm for 10 min and heated to have a temperature of 40° C., and ethylacetate was removed to have a concentration of 0.5% to prepare a [amorphous resin latex 2] having a central diameter of 310 nm. The latex had a solid content concentration of 10%.

| | |
|---|---|
| Amorphous resin latex 1 | 260 |
| Amorphous resin latex 2 | 120 |
| Cyan pigment dispersion B-1 | 10 |
| Release agent dispersion C-1 | 8 |
| Polyaluminum chloride | 0.15 |
| Ion-exchanged water | 400 |

The above-mentioned compositions were fully mixed and dispersed by a homogenizer ULTRA TURRAX T50 from IKA in a round stainless flask. The flask was heated to have a temperature of 48° C. in a heating oil bath while stirred to agglutinate particles. When the particle diameter was 5.8 μm, the mixture was adjusted to have a pH of 6.0 with an aqueous solution of sodium hydrate of 0.5 moIIl and heated to have a temperature of 80° C. while stirred. The mixture decreased pH to about 5.0 while heated to have a temperature of 80° C., but which was maintained. When the particles have a circularity of 0.970, the mixture was cooled.

Next, as a pre-washing process, 300 parts of ion-exchanged water were added to the resultant filtered cake and mixed by a T. K. HOMO MIXER at 12,000 rpm for 10 min, and filtered. This operation was performed twice.

Next, as an alkalization process, 300 parts of ion-exchanged water were added to the resultant filtered cake and mixed by a T. K. HOMO MIXER at 12,000 rpm for 30 min. An aqueous solution including sodium hydrate in an amount of 10% by weight was added thereto to have a pH of 11.0. Then, the filtered cake was stirred for 10 hrs while heated at 50° C. and cooled to have room temperature and filtered under reduced pressure.

Further, as an after-washing process, 300 parts of ion-exchanged water were added to the resultant filtered cake and mixed by a T. K. HOMO MIXER at 12,000 rpm for 10 min, and filtered. This operation was performed three times. Three hundred (300) parts of hydrochloric acid including a solid content of 1% by weight were added to the resultant filtered cake and mixed by a T. K. HOMO MIXER at 12,000 rpm for 10 min, and filtered. Finally, 300 parts of ion-exchanged water were added to the resultant filtered cake and mixed by a T. K. HOMO MIXER at 12,000 rpm for 10 min, and filtered. This operation was performed twice to prepare a filtered cake.

The resultant cake was pulverized and dried at 40° C. for 22 hrs to prepare a [resin particle 105] having a volume-average particle diameter of 5.7 μm.

One hundred (100) parts of the [resin particle 105] and 1.0 part of hydrophobic silica (H2000 from Clariant (Japan) K.K.) as an external additive were mixed by HENSCHEL MIXER from Mitsui Mining Co., Ltd. at a peripheral speed of 30 m/sec for 30 sec, and paused for 1 min, which was repeated for 5 times. Then, the particles were sieved by a mesh having an opening of 35 μm to prepare a [toner 105].

### Comparative Example 6

The procedure for preparation of the [toner 1] in Example 1 was repeated to prepare a [resin particle 106] and a [toner 106] except for having placed 60 parts of the [resin solution 1] instead of 45 parts thereof and not having used the [crystalline prepolymer 1].

### Comparative Example 7

The procedure for preparation of the [toner 1] in Example 1 was repeated to prepare a [resin particle 107] and a [toner 107] except for having placed 55 parts of the [resin solution 1] instead of 45 parts thereof and having placed 5 parts of the [crystalline prepolymer 1] instead of 15 parts thereof.

### Example 11

In a reaction vessel including a thermometer and a stirrer, 45 parts of the [resin solution 1], 15 parts of the [crystalline prepolymer 1], 14 part of the [wax dispersion 1] and 10 parts of the [colorant dispersion 1] were placed, and the mixture was stirred by a T. K. HOMO MIXER at 50° C. and 8,000 rpm to be uniformly dissolved and dispersed to prepare a [toner material liquid 1].

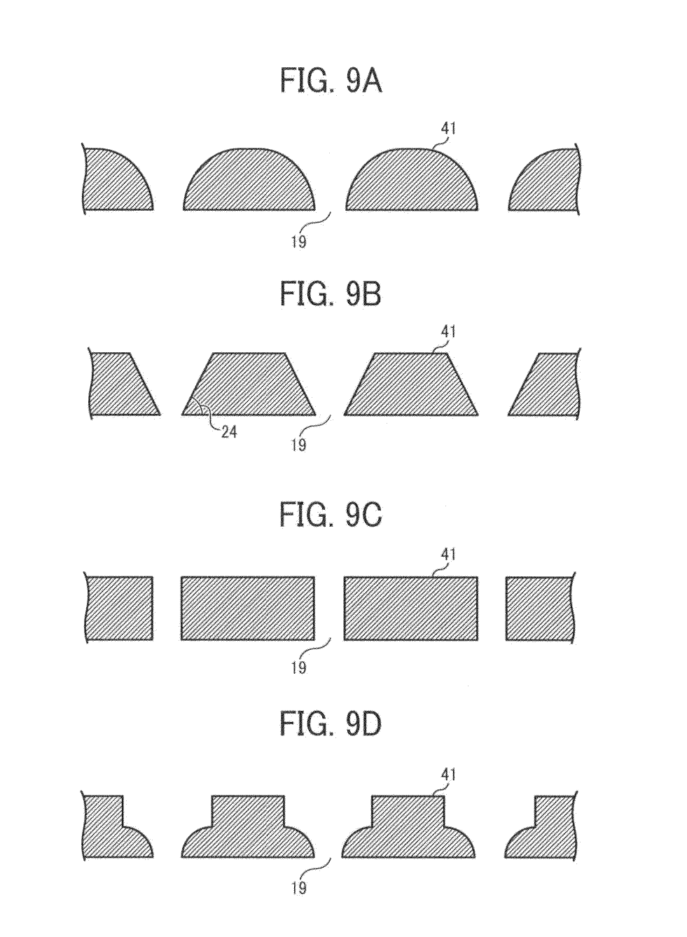

The [toner material liquid 1] was discharged from droplet discharge heads in FIGS. 9A to 9D using a liquid-column resonance principle under the following conditions. Then, the droplet was dried, solidified and collected by cyclone, and further dried at 35° C. for 48 hrs to prepare a [resin particle 11].

<Liquid-Column Resonant Conditions>

Resonance mode: N=2

Length of liquid-column resonance liquid chamber

in a longitudinal direction: L=1.8 mm

Frame end height at liquid common feed path side of

liquid-column resonance liquid chamber: h1=80 μm

Communication opening height of

liquid-column resonance liquid chamber: h2=40 μm

<Mother toner particle preparation conditions>

Specific gravity of dispersion: p=1.1 g/cm³

Shape of discharge opening: True circle

Diameter of discharge opening: 7.5 μm

The number of discharge openings: 4 per one liquid-column resonance liquid chamber

Shortest distance between centers of adjacent discharge openings: 130 μm (all equal)

Dry air temperature: 40° C.

Application voltage: 10.0 V

Drive frequency: 395 kHz

One hundred (100) parts of the [resin particle 11] and 1.0 part of hydrophobic silica (H2000 from Clariant (Japan) K.K.) as an external additive were mixed by HENSCHEL MIXER from Mitsui Mining Co., Ltd. at a peripheral speed of 30 m/sec for 30 sec, and paused for 1 min, which was repeated for 5 times. Then, the particles were sieved by a mesh having an opening of 35 p.m to prepare a [toner 11].

### Example 12

The procedure for preparation of the [toner 11] in Example 11 was repeated to prepare a [resin particle 12] and a [toner 12] except for replacing the [crystalline resin 1] with the [crystalline resin 2].

<Evaluation and Measurement Method>

### [Weight-Average Molecular Weight of THF-Soluble Component of Toner]

The molecular weight of the resin and the toner were measured by GPC (gel permeation chromatography) under the following conditions:

Measurer: GPC-150C from Waters Corp.

Column: KF801 to 807 from Shodex.

Temperature: 40° C.

Solvent: THF (tetrahydrofuran)

Flow speed: 1.0 ml/min

Measured Sample: 0.1 ml having a concentration of from 0.05 to 0.6%

When measuring a number-average and weight-average molecular weight of the sample, a molecular weight distribution of the sample was determined from a relation between a logarithmic value of a calibration curve prepared from several monodispersion polystyrene standard samples and a counter number. As the polystyrene standard samples for preparing the calibration curve, Showdex STANDARD Std. No. S-7300, S-210, S-390, S-875, S-1980, S-10.9, S-629, S-3.0 and S-0.580 and toluene were used. An RI (refraction index) detector was used as a detector.

[Methanol Wettability]

A toner sample was preliminarily was left in an environment of 23±2° C. and 50±5% RH for not 24 hrs or longer.

In a laboratory environment, a 20 mm long stirrer tip and 60 ml of ion-exchanged water were placed in a 100 ml tall beaker, an ultrasound was irradiated thereto to deaerate and set in a powder wettability tester WET-100P from Rhesca Corp. On the ion-exchanged water, 25 mg of the toner sample was floated, and quickly a lid and a methanol feed nozzle were quickly set to start stirring with the stirrer and measuring. Methanol was fed at 1.6 ml/min and measurement time was 30 min. The stirrer stirred at from 350 to 450 rpm. The toner floated on an interface of the ion-exchanged water at the beginning and gradually wetted with a mixed liquid of the ion-exchanged water and methanol as methanol increased in concentration. The toner was dispersed therein and the liquid decreased in light transmission. Wettability was evaluated from this light transmission. Specifically, a methanol concentration (% by volume) determined from Flow (ml) was plotted on x-axis and a light transmission (voltage ratio (%)) was plotted on y-axis, and the methanol concentration at the middle of the maximum and minimum values was “50% wettability (W(50%)) in methanol wettability test”. When the voltage ratio did not fall below 70%, the 50% wettability (W(50%)) was “not less than measurement limit”.

As a matter of course, in this case, the toner has very low methanol wettability, i.e., the surface thereof has high hydrophobicity and variation of chargeability thereof is preferably prevented.

[Fixability]

A copier MF-200 using a TEFLON roller (a registered trademark) as a fixing roller from Ricoh Company, Ltd., the fixer in which was modified was used to produce solid images having a toner adherence amount of 0.85±0.1 mg/cm² on receiving papers TYPE 6200 from Ricoh Company, Ltd. and <135> from NBS Ricoh Co., Ltd., while the temperature of the fixing belt was increased at a unit of 5° C. from 90° C.

A sapphire needle 125 μm was run on the solid image at a needle rotation diameter of 8 mm and a load of 1 g using a tracing tester AD-401 from Ueshima Seisakusho Co., Ltd. A scratch (trace) of the sapphire needle on the image was visually observed. A minimum temperature at which no scratch was observed was minimum fixable temperature. In addition, the glossiness of the image increased as the fixing temperature increased, but began to decrease at a specific temperature. This is because the image surface is roughened since the toner is somewhat subjected to hot offset. A maximum temperature at which no deterioration of glossiness was observed was maximum fixable temperature.

[Chargeability]

The resultant toner and a carrier used in MFP imagio MP C4500 from Ricoh Company, Ltd. were left for 24 hrs or longer in a high temperature and high humidity (HH) environment (28° C./90%) or a low temperature and low humidity (LL) environment (10° C./15%). Then, 0.7 g of the toner and 10 g of the carrier were placed in a PP container and mixed for 1 min to measure a charge quantity by a blowoff method.

[Toner Surfaceness]

The surface of the resin particle was observed by a scanning electron microscope (SEM) at 20,000 magnification.

[Atomic Ratio (F/C) of Fluorine Atom to Carbon Atom on the Surface of Toner]

An atomic ratio of fluorine atoms to carbon atoms on the surface of the toner in the present invention can be determined by an XPS (X-ray photoelectron spectroscopy) apparatus.

In the present invention the following apparatus ad conditions were used.

(1) A pre-treated toner was packed in an aluminum plate and lightly pushed from above to measure.

(2) X-ray photoelectron spectral apparatus 1600S from PHI was used.

(3) X-ray source was MgKα (100 W) and analysis range was 0.8×2.0 mm.

TABLE 1-1

| | Washing | | |
|---|---|---|---|
| | pH | ° C. | Hr |
| Example 1 | 11 | 45 | 10 |
| Example 2 | 12 | 45 | 10 |
| Example 3 | 10 | 45 | 10 |
| Example 4 | 11 | 55 | 10 |
| Example 5 | 11 | 45 | 10 |
| Example 6 | 11 | 45 | 10 |
| Example 7 | 12 | 45 | 2 |
| Example 8 | 12 | 40 | 10 |
| Example 9 | 11 | 45 | 10 |
| Example 10 | 11 | 45 | 10 |
| Comparative Example 1 | — | — | — |
| Comparative Example 2 | 11 | 20 | 10 |
| Comparative Example 3 | — | 50 | 10 |
| Comparative Example 4 | 11 | 50 | 10 |
| Comparative Example 5 | 11 | 50 | 10 |
| Comparative Example 6 | 11 | 45 | 10 |
| Comparative Example 7 | 11 | 45 | 10 |

TABLE 1-2

| | | | XPS |
|---|---|---|---|
| | Mw | W (50%) | F/C |
| Example 1 | 32,000 | 41 | <0.001 |
| Example 2 | 32,000 | Measurement limit or more | <0.001 |
| Example 3 | 32,000 | 23 | <0.001 |
| Example 4 | 32,000 | Measurement limit or more | <0.001 |
| Example 5 | 28,000 | 42 | <0.001 |
| Example 6 | 31,000 | Measurement limit or more | <0.001 |
| Example 7 | 32,000 | 36 | <0.001 |
| Example 8 | 32,000 | 39 | <0.001 |
| Example 9 | 32,000 | Measurement limit or more | 0.021 |
| Example 10 | 32,000 | 40 | <0.001 |
| Comparative Example 1 | 32,000 | 13 | <0.001 |
| Comparative Example 2 | 32,000 | 16 | <0.001 |
| Comparative Example 3 | 32,000 | 15 | <0.001 |
| Comparative Example 4 | 12,500 | 19 | <0.001 |
| Comparative Example 5 | 11,200 | 18 | <0.001 |
| Comparative Example 6 | 16,000 | 41 | <0.001 |
| Comparative Example 7 | 14,600 | Measurement limit or more | <0.001 |

TABLE 1-3

| | | | | Crystallization |
|---|---|---|---|---|
| | Tₛₕ^{2nd}/Tₛₕ^{1st} | G′ (70) | G′ (160) | (%) |
| Example 1 | 1.02 | 4.2 × 10⁵ | 3.0 × 10³ | 22 |
| Example 2 | 0.97 | 4.1 × 10⁵ | 2.9 × 10³ | 23 |
| Example 3 | 0.92 | 4.4 × 10⁵ | 3.1 × 10³ | 25 |
| Example 4 | 1.06 | 4.2 × 10⁵ | 2.9 × 10³ | 27 |
| Example 5 | 1.01 | 3.8 × 10⁵ | 2.4 × 10³ | 22 |
| Example 6 | 0.96 | 3.3 × 10⁵ | 7.2 × 10³ | 30 |
| Example 7 | 1.09 | 4.1 × 10⁵ | 3.0 × 10³ | 25 |
| Example 8 | 1.04 | 4.3 × 10⁵ | 3.1 × 10³ | 27 |
| Example 9 | 0.99 | 4.2 × 10⁵ | 3.1 × 10³ | 22 |
| Example 10 | 0.94 | 4.3 × 10⁵ | 3.0 × 10³ | 23 |
| Comparative | 1.02 | 4.6 × 10⁵ | 3.4 × 10³ | 27 |
| Example 1 | | | | |
| Comparative | 0.97 | 4.4 × 10⁵ | 3.1 × 10³ | 22 |
| Example 2 | | | | |
| Comparative | 0.92 | 4.9 × 10⁵ | 3.2 × 10³ | 23 |
| Example 3 | | | | |
| Comparative | 0.87 | 2.2 × 10⁵ | 5.3 × 10³ | 0 |
| Example 4 | | | | |
| Comparative | 0.84 | 7.8 × 10⁵ | 8.8 × 10² | 0 |
| Example 5 | | | | |
| Comparative | 0.95 | 1.3 × 10³ | 5.5 × 10² | 29 |
| Example 6 | | | | |
| Comparative | 1.09 | 2.6 × 10³ | 6.2 × 10² | 23 |
| Example 7 | | | | |

TABLE 1-4

| | Fixability | | Charge | | |
|---|---|---|---|---|---|
| | Min. | Max. | LL | HH | Variation (%) |
| Example 1 | 95 | 220 | 45 | 29 | 43 |
| Example 2 | 90 | 210 | 48 | 30 | 46 |
| Example 3 | 100 | 220 | 44 | 30 | 38 |
| Example 4 | 90 | 220 | 46 | 30 | 42 |
| Example 5 | 95 | 220 | 43 | 28 | 42 |
| Example 6 | 105 | 150 | 49 | 33 | 39 |
| Example 7 | 95 | 220 | 46 | 29 | 45 |
| Example 8 | 95 | 220 | 46 | 30 | 42 |
| Example 9 | 105 | 220 | 49 | 28 | 55 |
| Example 10 | 95 | 220 | 45 | 30 | 40 |
| Comparative Example 1 | 115 | 190 | 37 | 10 | 115 |
| Comparative Example 2 | 115 | 190 | 39 | 15 | 89 |
| Comparative Example 3 | 115 | 195 | 38 | 12 | 104 |
| Comparative Example 4 | 110 | 125 | 45 | 16 | 95 |
| Comparative Example 5 | 115 | 120 | 47 | 17 | 94 |
| Comparative Example 6 | 95 | 110 | 45 | 28 | 47 |
| Comparative Example 7 | 100 | 115 | 48 | 30 | 46 |

TABLE 1-5

| | SEM |
|---|---|
| Example 1 | Smooth |
| Example 2 | Smooth |
| Example 3 | Smooth |
| Example 4 | Smooth |
| Example 5 | Smooth |
| Example 6 | Smooth |
| Example 7 | Smooth |
| Example 8 | Smooth |
| Example 9 | Smooth |
| Example 10 | Smooth |
| Comparative Example 1 | Concave and convex |
| Comparative Example 2 | Slightly concave and convex |
| Comparative Example 3 | Slightly concave and convex |
| Comparative Example 4 | Holey |
| Comparative Example 5 | Holey |
| Comparative Example 6 | Smooth |
| Comparative Example 7 | Smooth |

Each of the toners of Examples 1 to 9 and Comparative Examples 6 and 7 has a smooth surface because materials such as resins having a high-polarity function group are thought removed. Each of the toners of Comparative Examples 1 to 3 has concave and convex surface because remaining materials such as resins having a high-polarity function group are thought to have deteriorated fixability and chargeability at high temperature and high humidity. Each of the toners of Comparative Examples 4 and 5 has microscopic holes because it is thought the toner was plasticized and the resin was partly hydrolyzed while prepared. As a result, it is thought the toner had a larger surface area and received a larger charge quantity at low temperature and low humidity, but was largely affected by moisture and received a lower charge quantity at high temperature and high humidity, resulting in large variation of charge quantity.

TABLE 2-1

| | Washing | | |
|---|---|---|---|
| | pH | ° C. | Hr |
| Example 11 | — | — | — |
| Example 12 | — | — | — |

TABLE 2-2

| | | | XPS |
|---|---|---|---|
| | Mw | W (50%) | F/C |
| Example 11 | 32,000 | 56 | <0.001 |
| Example 12 | 28,000 | Measurement limit or more | <0.001 |

TABLE 2-3

| | | | | Crystallization |
|---|---|---|---|---|
| | Tₛₕ^{2nd}/Tₛₕ^{1st} | G′ (70) | G′ (160) | (%) |
| Example 11 | 1.02 | 4.2 × 10⁵ | 3.0 × 10³ | 22 |
| Example 12 | 1.01 | 3.8 × 10⁵ | 2.4 × 10³ | 22 |

TABLE 2-4

| | |
|---|---|
| Fixability | Charge |

| | Min. | Max. | LL | HH | Variation (%) |
|---|---|---|---|---|---|
| Example 11 | 95 | 220 | 48 | 32 | 40 |
| Example 12 | 95 | 220 | 46 | 31 | 39 |

TABLE 2-5

| | SEM |
|---|---|
| Example 11 | Smooth |
| Example 12 | Smooth |

Having now fully described the invention, it will be apparent to one of ordinary skill in the art that many changes and modifications can be made thereto without departing from the spirit and scope of the invention as set forth therein.

What is claimed is:

1. A toner, comprising a crystalline resin as a binder resin, wherein the toner comprises a THF-soluble component in a weight-average molecular weight not less than 20,000, and has a 50% wettability not less than 20% by volume when subjected to a methanol wettability test.

2. The toner of claim 1, wherein the binder resin comprises the crystalline resin in an amount not less than 50% by weight.

3. The toner of claim 1, wherein the crystalline resin is a crystalline polyester resin.

4. The toner of claim 1, wherein the crystalline resin comprises at least one of a urethane bond and a urea bond.

5. The toner of claim 1, wherein the crystalline resin comprises:
a first crystalline resin; and
a second crystalline resin having a weight-average molecular weight larger than that of the first crystalline resin.

6. The toner of claim 5, wherein the second crystalline resin is formed by elongating a modified crystalline resin having an isocyanate group at an end.

7. The toner of claim 5, wherein the first crystalline resin comprises at least one of a urethane bond and a urea bond, and the second crystalline resin is formed by elongating the first crystalline resin.

8. The toner of claim 1, wherein the crystalline resin is a block polymer of polyester and polyurethane.

9. The toner of claim 1, wherein the toner has a crystallization not less than 10% when subjected to an X-ray diffraction measurement.

10. The toner of claim 1, wherein the toner has a ratio [Tsh(2^{nd})/Tsh(1^{st})] of a shoulder temperature of a melting heat peak of a second heating Tsh(2nd) [° C.] to a shoulder temperature of a melting heat peak of a first heating Tsh1st [° C.] when measured by the differential scanning calorimeter (DSC) of from 0.90 to 1.10.

11. The toner of claim 1, wherein the toner has a storage elastic modulus at 70° C. G′ (70) Pa and a storage elastic modulus at 160° C. G′ (160) Pa satisfying the following relationships:
5.0×10⁴<G′ (70)<5.0×10⁵
1.0×10³<G′ (160)<1.0×10⁴.

12. The toner of claim 1, wherein the toner is obtained by granulating a toner material liquid comprising the binder resin in an aqueous medium.

13. A method of preparing a toner, comprising:
granulating a mother toner comprising a crystalline resin as a binder resin in an aqueous medium; and
heating the mother toner in an alkaline,
wherein the toner comprises a THF-soluble component in a weight-average molecular weight not less than 20,000, and has a 50% wettability not less than 20% by volume when subjected to a methanol wettability test.
